(19) United States
(12) Patent Application Publication
(10) Pub. No.: US 2012/0102362 A1
(43) Pub. Date: Apr. 26, 2012

(54) MANAGEMENT SYSTEM AND MANAGEMENT METHOD

(75) Inventors: Yasuhiko Onitsuka, Yokohama (JP); Takaki Kuroda, Machida (JP)

(73) Assignee: Hitachi, Ltd.

(21) Appl. No.: 13/055,443

(22) PCT Filed: Oct. 22, 2010
(86) PCT No.: PCT/JP2010/068717

§ 371 Date: Jan. 21, 2011

(51) Int. Cl. G06F 11/07

(52) U.S. Cl. 714/37; 714/E11.029

(57) ABSTRACT

The present invention realizes root cause analysis processing with a high certainty factor while holding down management cost. In the present invention, besides one or more condition events which could occur in a node apparatus, an additional event different from the condition events is introduced into an analysis rule for a root cause analysis. This analysis rule indicates a relation between the condition events and additional event and a conclusion event recognized as a failure factor according to satisfaction of the condition events and additional event. The additional event is a command for instructing execution of an action for acquiring additional information from the node apparatus according to a satisfaction state of the one or more condition events. A detected state is applied to the analysis rule, a certainty factor as information indicating possibility of occurrence of a failure in the node apparatus is calculated on the basis of satisfaction or non-satisfaction of the condition events and an execution result of the action, and a root cause analysis result is generated. The obtained root cause analysis result is output according to necessity.

### TECHNICAL FIELD

The present invention relates to a management system and a management method for managing a monitoring target apparatus included in a computer system and relates to, for example, a management system and a management method for providing a root cause analysis result.

### BACKGROUND ART

When a computer system is managed, for example, as disclosed in Patent Literature 1, an event as a cause is detected out of plural failures or signs of the failures detected in the system. This is called root cause analysis (RCA). More specifically, in Patent Literature 1, excess of a threshold of a performance value in a managed apparatus is converted into an event using management software and information is accumulated in an event DB.

This management software includes an analysis engine for analyzing causality of plural failure events occurred in the managed apparatus. This analysis engine accesses a configuration DB including inventory information of the managed apparatus, recognizes apparatus internal components present on a path on an I/O route, and recognizes components, which could affect the performance of a logical volume on a host, as a group called “topology”. When an event occurs, the analysis engine applies an analysis rule including a predetermined conditional sentence and an analysis result to topologies and establishes an expansion rule. This expansion rule includes a cause event as a case of performance deterioration in other apparatuses and a related event group caused by the cause event. Specifically, an event described as a cause of a failure in a THEN part of the rule is a cause event and events other than the cause event among condition events described in an IF part are related events.

### CITATION LIST

### Patent Literature

Patent Literature 1: U.S. Pat. No. 7,107,185

### SUMMARY OF INVENTION

### Technical Problem

In the root cause analysis technique explained above, cause analysis processing with a high certainty factor cannot be realized unless a management computer detects events or states concerning a large number of conditions described in the expansion rule. In other words, an event described in a conclusion part of the expansion rule cannot be determined as a root cause one hundred percent unless all events or conditions of a condition part described in the expansion rule are detected. Therefore, even if there is a monitoring target apparatus determined as a failure cause from state information of connected peripheral monitoring target apparatuses, a root cause cannot be specified with a high certainty factor unless a state which should be received from the monitoring target apparatus determined as the root cause is detected.

From such a viewpoint, it is desirable that the management computer detects, as much as possible, events or states which the monitoring target apparatuses could cause.

However, in the management target apparatuses, when the management computer attempts to detect events and states, which should be set as monitoring targets, as many as possible, a processing load, detection time, memory usage, and the like increase. As a result, a problem occurs in that management cost for the monitoring target apparatuses increases.

The present invention has been devised in view of such circumstances and realizes root cause analysis processing with, a high certainty factor while holding down management cost.

### Solution to Problem

In order to solve the problems, in the present invention, besides one or more condition events which could occur in a node apparatus, an additional event different from the condition events is introduced into an analysis rule for a root cause analysis. This analysis rule indicates a relation between the condition events and additional event and a conclusion event recognized as a failure factor according to satisfaction of the condition events and additional event. The additional event is a command for instructing execution of an action for acquiring additional information from the node apparatus according to a satisfaction state of the one or more condition events. A detected event or a state is applied to the analysis rule, a certainty factor as information indicating possibility of occurrence of a failure in the node apparatus is calculated on the basis of satisfaction or non-satisfaction of the condition events and an execution result of the action, and a root cause analysis result is generated. The obtained root cause analysis result is output according to necessity.

### Advantageous Effects of Invention

According to the present invention, it is possible to realize root cause analysis processing with a high certainty factor while holding down management cost.

Further problems, configurations, operational effects other than those explained above are made clear by modes for carrying out the present invention explained below and attached drawings.

### BRIEF DESCRIPTION OF DRAWINGS

FIG. 1 is diagram for explaining a general method of a root cause analysis and a problem of the method (an example 1).

FIG. 2 is a diagram for explaining a general method of a root cause analysis and a problem of the method (an example 2).

FIG. 3 is a diagram (1) for explaining a concept of a root cause analysis according to the present invention.

FIG. 4 is a diagram (2) for explaining the concept of the root cause analysis according to the present invention.

FIG. 5 is a diagram showing a physical configuration of a computer system according to an embodiment of the present invention.

FIG. 6 is a diagram showing a detailed internal configuration example of a host computer according to the embodiment of the present invention.

FIG. 7 is a diagram showing a detailed internal configuration example of a network apparatus according to the embodiment of the present invention.

FIG. 8 is a diagram showing a detailed internal configuration example of a storage apparatus according to the embodiment of the present invention.

FIG. 9 is a diagram showing a detailed internal configuration example of a management server according to the embodiment of the present invention.

FIG. 10 is a diagram showing a structure example of a various setting values definition table according to the embodiment of the present invention.

FIG. 11 is a diagram showing a structure example of a configuration-information-for-node management table according to the embodiment of the present invention.

FIG. 12 a diagram showing a structure example of a configuration-information-for-component management table according to the embodiment of the present invention.

FIG. 13 is a diagram showing an example of an RCA universal rule according to the embodiment of the present invention.

FIG. 14 is a diagram showing an example of an action universal rule according to the embodiment of the present invention.

FIG. 15 is a diagram showing an example of a component attribute information table and an expansion pattern (a rule expansion topology) used for expanding the RCA universal rule according to the embodiment of the present invention.

FIG. 16 is a diagram showing an example of an RCA expansion rule according to the embodiment of the present invention.

FIG. 17 is a diagram showing an example of an action expansion rule according to the embodiment of the present invention.

FIG. 18 is a diagram showing a structure example of an event table according to the embodiment of the present invention.

FIG. 19 is a diagram showing a structure example of an action definition table according to the embodiment of the present invention.

FIG. 20 is a diagram showing a structure example of an action execution management table according to the embodiment of the present invention.

FIG. 21 is a diagram showing a structure example of an action expansion rule table according to the embodiment of the present invention.

FIG. 22 is a diagram showing a structure example of an action expansion rule ID-event ID relation table according to the embodiment of the present invention.

FIG. 23 is a diagram showing a structure example of an RCA expansion rule ID-event ID/action ID relation table according to the embodiment of the present invention.

FIG. 24 is a diagram showing a structure example of an event/action expiration data management table according to the embodiment of the present invention.

FIG. 25 is a diagram showing a structure example of an RCA expansion rule table according to the embodiment of the present invention.

FIG. 26 is a diagram showing a structure example of a conclusion table according to the embodiment of the present invention.

FIG. 27 is a diagram showing a structure example of a conclusion ID-event ID relation table according to the embodiment of the present invention.

FIG. 28 is a diagram showing a structure example of a conclusion ID-action ID relation table according to the embodiment of the present invention.

FIG. 29 is a diagram showing a structure example of an internal program of a management program according to the embodiment of the present invention.

FIG. 30 is a flowchart for explaining an overall outline of processing periodically executed according to the embodiment of the present invention.

FIG. 31 is a flowchart for explaining details of management program initialization processing (S301) according to the embodiment of the present invention.

FIG. 32 is a flowchart for explaining details of event collection processing (S304) according to the embodiment of the present invention.

FIG. 33 is a flowchart for explaining collected event processing for reflecting collected (detected) events on the tables according to the embodiment of the present invention.

FIG. 34 is a flowchart for explaining details of addition processing (S336) for the number of detected events of the action expansion rule according to the embodiment of the present invention.

FIG. 35 is a flowchart for explaining details of addition processing (S337) for the number of detected events/the number of satisfied actions of the RCA expansion rule according to the embodiment of the present invention.

FIG. 36 is a flowchart for explaining details of expiration management processing (S305) according to the embodiment of the present invention.

FIG. 37 is a flowchart for explaining details of subtraction processing (S3053) for the number of detected events or states 32114 of the action expansion rule according to the embodiment of the present invention.

FIG. 38 is a flowchart for explaining details of subtraction processing (S3054) for the number of detected events/the number of satisfied actions of the RCA expansion rule according to the embodiment of the present invention.

FIG. 39 is a flowchart for explaining action execution according to the embodiment of the present invention.

FIG. 40 is a flowchart for explaining details of action execution processing (S393) according to the embodiment of the present invention.

FIG. 41 is a flowchart for explaining RCA result output processing according to the embodiment of the present invention.

FIG. 42 is a flowchart for explaining conclusion table update processing according to the embodiment of the present invention.

FIG. 43 is a flowchart for explaining conclusion ID-event ID relation table update processing according to the embodiment of the present invention.

FIG. 44 is a flowchart for explaining conclusion ID-action ID relation table update processing according to the embodiment of the present invention.

FIG. 45 is a diagram showing an example of an RCA result output screen (a present result: list display) according to the embodiment of the present invention.

FIG. 46 is a diagram showing an example of an RCA result output screen (a present result: detailed display) according to the embodiment of the present invention.

### DESCRIPTION OF EMBODIMENTS

An embodiment of the present invention is explained below with reference to the accompanying drawings. However, it should be noted that this embodiment is only an example for realizing the present invention and does not limit the technical scope of the present invention. In the figures, common components are denoted by the same reference numbers.

In this specification, information used in the present invention is explained by an expression “aaa table”. However, the information may be represented by an expression such as “aaa table,” “aaa list,” “aaa DB” or “aaa queue” or may be represented by an expression other than data structures such as a table, a list, a DB, and a queue. Therefore, in order to indicate that information used in the present invention does not depend on a data structure, in some cases, “aaa table,” “aaa chart,” “aaa list,” “aaa DB,” “aaa queue” and the like are called “aaa information.”

When contents of information are explained, in some cases, expressions “identification information,” “identifier,” “name,” “appellation” and “ID” are used. However, these expressions can be interchanged.

Further, in the following explanation of processing operations of the present invention, in some cases, the explanation is made assuming that “program” or “module” as an operation entity (a subject). However, since the program or the module is executed by a processor to perform decided processing using a memory and a communication port (a communication control apparatus). Therefore, the processing operations may be read as processing with the processor assumed as the operation entity (the subject). Processing disclosed with the program or the module assumed as the subject may be processing performed by a computer (a management computer, etc.) such as a management server or an information processing apparatus. A part of the program or the entire program may be realized by dedicated hardware. Various programs may be installed in computers by a program distribution server or a storage medium.

In the embodiment described in this specification, the size of a system set as a management target is not referred to. However, as the system becomes larger, it is more highly likely that failures occur in plural places simultaneously and frequently. Therefore, when the present invention is applied to a large system, the effects of the present invention can be further enjoyed.

<Concept of a Root Cause Analysis>

(1) General Method

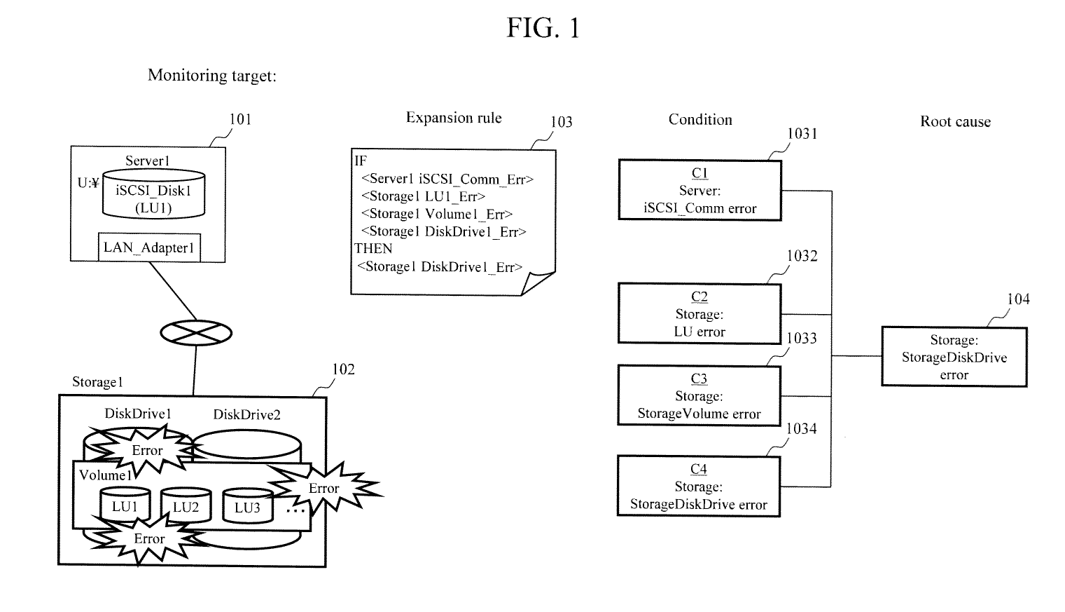

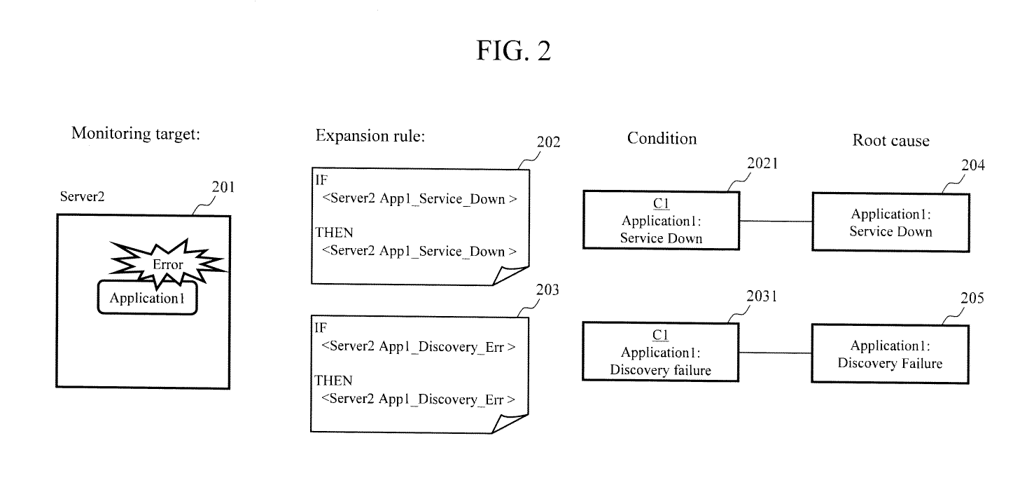

FIGS. 1 and 2 are diagrams for explaining a general method of a root cause analysis and a program of the method (an example). FIG. 1 shows an outline of root cause analysis processing with a server 1_101 and a storage apparatus 1_102 set as monitoring target apparatuses and by applying an expansion rule 103. The expansion rule 103 includes condition events 1031 to 1034 in an IF part and includes a cause event 104 in a THEN part. In other words, when all the condition events 1031 to 1034 occur, the cause event 104 is determined as a root cause of a failure with a certainty factor of 100%.

However, since an error in the storage apparatus 1_102 is easily detected, the condition events 1032 and 1034 are satisfied. However, it is not easy to detect an error from iSCSI_Disk1 in the server 1_101. This is because, even when LU1 of the storage apparatus 1_102 allocated to U:¥ of the server 1101 is inaccessible, since an OS of the server 1_101 attempts to perform write processing in a cache and carryout detailed writing in an actual Disk, an error of the iSCSI_Disk1 cannot be detected in some cases. Therefore, if an error of the iSCSI_Disk1 cannot be detected, an analysis result by the expansion rule 103 cannot be obtained with a certainty factor of 100%.

FIG. 2 shows an outline of root cause analysis processing executed with a server 2_201 set as a monitoring target apparatus and by applying expansion rules 202 and 203. Each of the expansion rules 202 and 203 includes a condition event 2021 or 2031 in an IF part and includes a cause event 204 or 205 in a THEN part. In other words, according to the expansion rules 202 and 203, when a service is down in an application 1 in the server 2_201 or when a discovery error of the application 1 occurs, it is instantaneously determined that the service down or the discovery error of the application 1 occurs.

However, even if such an error can be detected from the application 1, the error is not always a root cause of a failure. In other words, an information amount is insufficient for specifying such a root cause of a failure and a correct root cause analysis cannot be performed.

(2) Method of the Present Invention

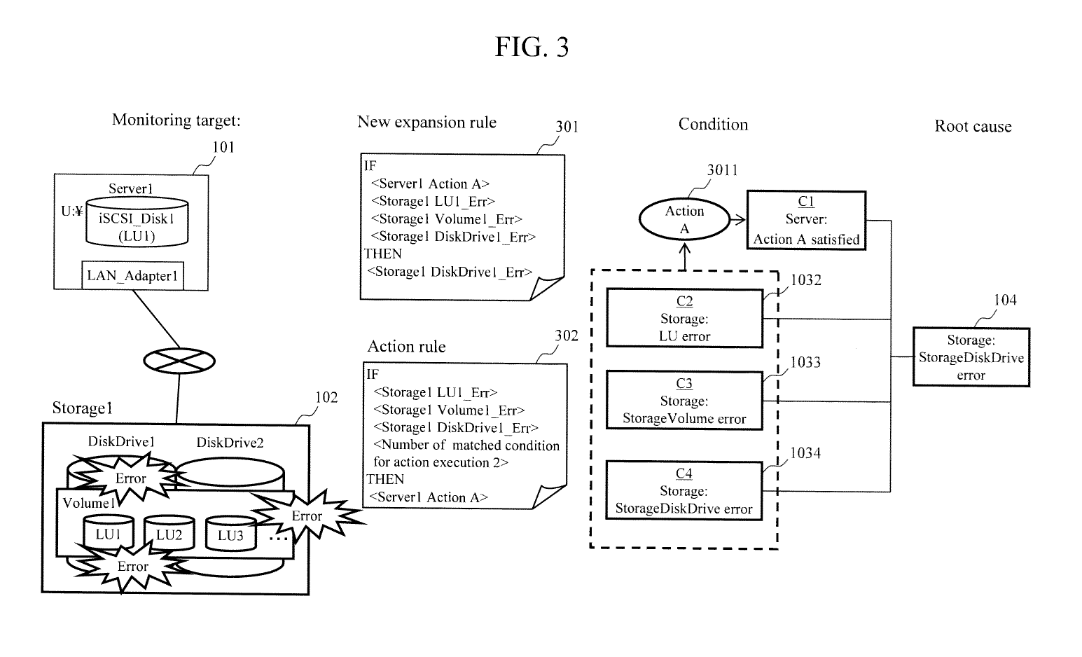

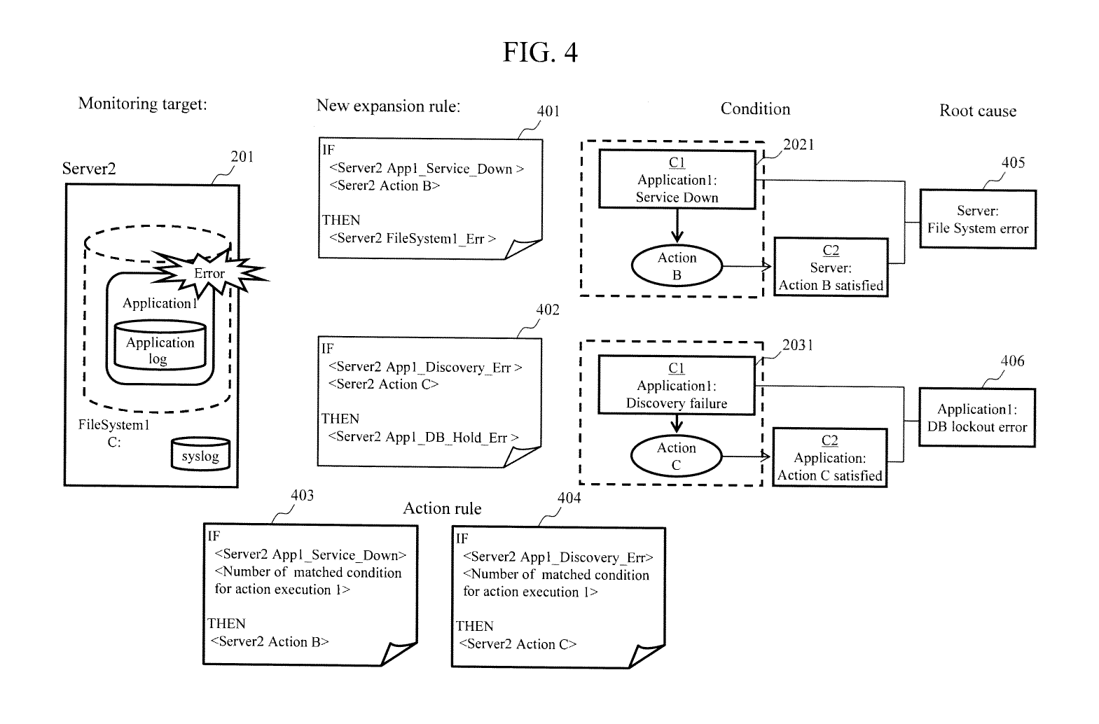

(i) Therefore, in the present invention, a new expansion rule based on a new idea is introduced. FIGS. 3 and 4 are diagrams for explaining a concept of a root cause analysis according to the present invention. FIG. 3 shows a concept for solving the problem in FIG. 1. FIG. 4 shows a concept for solving the problem in FIG. 2.

FIG. 3 is the same as FIG. 1 in that the monitoring target apparatuses are the server 1_101 and the storage apparatus 1_102. However, an expansion rule which should be applied is different. In a new expansion rule 301, an action A3011 is executed instead of an iSCSI_Disk1 error, which is an item not easily detected, for example, a system log (also called a syslog) of the server 1_101 is checked, and a condition event is set concerning whether an error of the iSCSI_Disk1 is satisfied. A rule for determining whether the action A is executed is an action rule. In an example shown in FIG. 3, the rule is set to execute the action A when two or more of condition events 1032 to 1034 are satisfied.

By applying such a new rule, even an error not easily detected can be checked. Therefore, it is possible to realize a root cause analysis with reliability higher than that of the general method.

The same applies in FIG. 4. A monitoring target apparatus is a server 2_201 and a root cause analysis is executed by applying new expansion rules 401 and 402. As content of the expansion rules 401 and 402, in addition to whether or not an item 2021 or 2031 of a general condition event is satisfied, an action B or an action C is executed to verify satisfaction of a predetermined execution result. Rules for determining whether the action B or C is executed are action rules 403 and 404. In an example shown in FIG. 4, a rule is set to execute, if the condition event 2021 or 2031 is satisfied, the additional action B or C corresponding to the condition event.

In FIG. 4, if the condition event 2021 and an event by the action B are satisfied, it is determined that a file system error in the server 2 is a root cause of a failure. If the condition event 2031 and an event by the action C are satisfied, it is determined that a DB lockout error in the application 1 is a root cause of a failure.

In this way, a new action execution result is set as an additional event in the conventional condition events. Therefore, it is possible to improve a situation in which an information amount is insufficient and an analysis result cannot be trusted.

(ii) In the monitoring target apparatuses, depending on types of events or states (e.g., metric such as a processing amount processed by a component per unit time and an error or a failure occurred in the component), contents of the events or the states are stored in different apparatus internal information (tables or logs in the apparatuses).

However, costs in management (e.g., a load, time, and a memory capacity) for a management computer to detect event or state content are different depending on apparatus internal information or a protocol for transmitting information necessary for detecting an event or a state from a monitoring target apparatus to the management computer. These costs in management depend on types of the monitoring target apparatus and a component. Therefore, in some cases, the costs can be easily acquired in a certain apparatus but cannot be easily acquired in another apparatus.

In the embodiment of the present invention, even when there is fluctuation in processing for detecting an event or a state in this way, as explained above, separately from the check of whether or not a condition event of an expansion rule is satisfied, an action is executed and whether or not an error is satisfied is checked on the basis of a result of the action.

(iii) Other Characteristics

The management computer is configured to detect, after detecting event or state content defined in advance, additional event or state content for executing the action. In order to detect the additional event or state content, the management computer executes additional information collection processing on the monitoring target apparatus (hereinafter referred to as “executes an action”). As explained above, this action is carried out when the management computer detects the event or state content defined in advance from the monitoring target apparatus. An event or state content group as conditions for executing the action (condition events in an RCA expansion rule), content of the action to be executed, and the number of satisfied condition events necessary for the execution of the action are defined in advance as an action rule. The action rule is expanded according to an actual environment (an action expansion rule) in the same manner as the RCA expansion rule and the action is executed according to a condition event detection situation. A condition part of the RCA expansion rule includes anew, in addition to the conventional event or state content detected from the monitoring target apparatus, an execution result of the action executed according to the action expansion rule.

“Under processing” of action execution may be controlled. It is likely that the same action is requested by plural action rules. For example, a server A is requested by a certain action rule to perform system log investigation and, while executing the system log investigation, requested by another action rule to perform the same system log investigation. While an action by a certain action rule is being processed, when the same action is requested by another action rule, rather than the processing being redundantly executed, after a result of the action already under processing is obtained, the result is diverted.

Further, if an execution result of the same action is obtained without the same action being executed many times, the execution result is diverted. It is likely that the same action is requested plural times at a short interval. Within time in which an investigation result can be regarded as the same (this is called an action effective period), a result of the last execution is diverted. The action effective period may be set different according to a type of an action. For example, it is assumed that content of an action is “investigate whether “DB lockout error” occurs in a monitoring target apparatus in a range of recent one hour”. In this case, for example, within one hour from time when the action is executed, even when the same action is requested, a result of the action executed first is diverted.

<System Configuration>

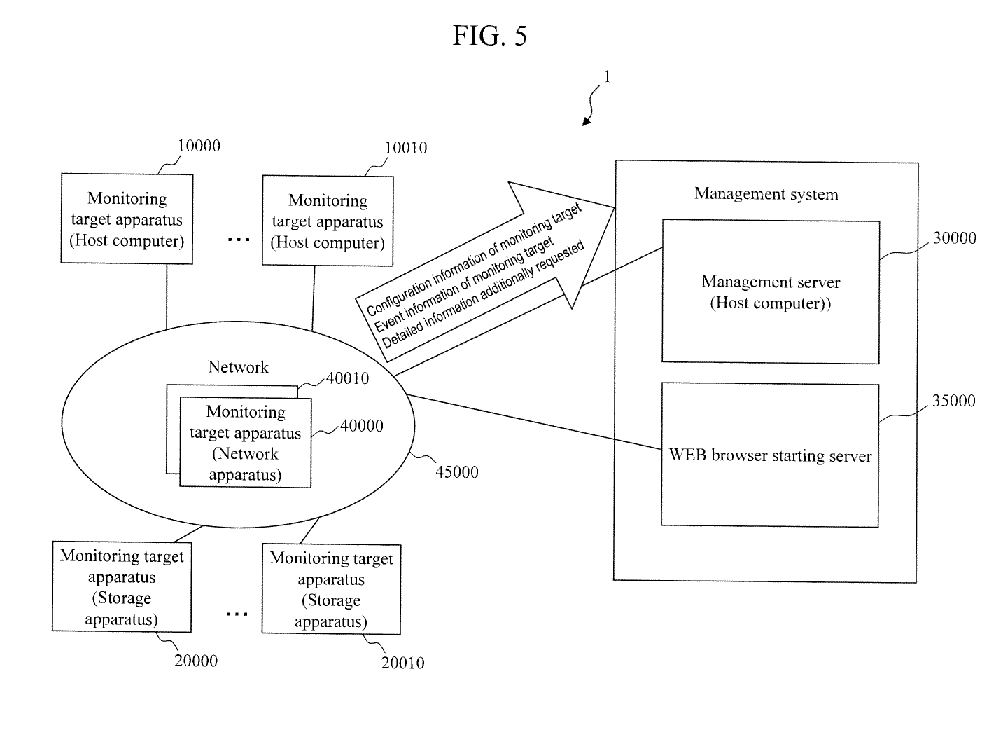

FIG. 5 is a diagram showing a physical configuration of a computer system according to the embodiment of the present invention. This computer system 1 includes a storage apparatus 20000, a host computer 10000, a management server 30000, a WEB browser starting server 35000, and a network apparatus (e.g., an IP switch) 40000, which are connected by a network 45000.

Host computers 10000 to 10010 receive, for example, an I/O request for a file from a not-shown client computer connected to the host computers 10000 to 10010 and realize accesses to storage apparatuses 20000 to 20010 on the basis of the I/O request. The management server (a management computer) 30000 manages the operation of the entire computer system 1.

The WEB browser starting server 35000 communicates with a GUI display processing module 32400 of the management server 30000 via the network 45000 and displays various kinds of information on a WEB browser. A user refers to the information displayed on the WEB browser on the WEB browser starting server to manage apparatuses in the computer system. However, the management server 30000 and the WEB browser starting server 35000 may be configured by one server.

<Internal Configuration of the Host Computer>

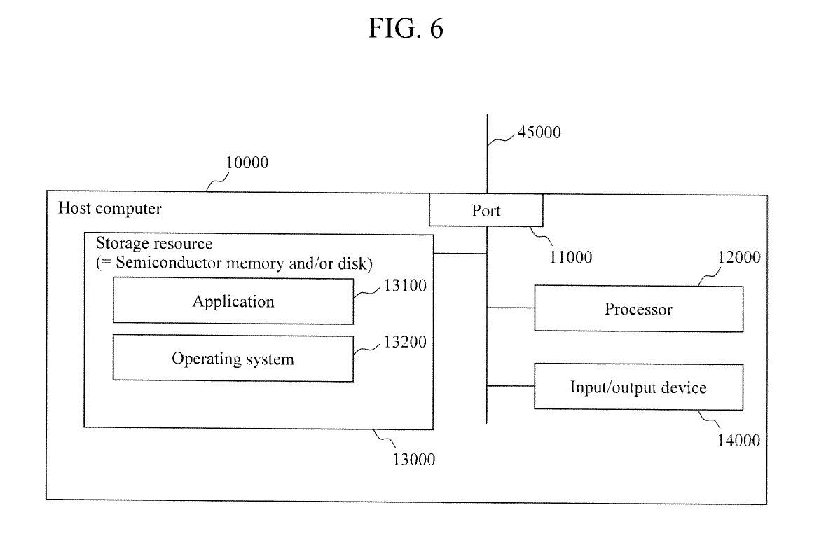

FIG. 6 is a diagram showing a detailed internal configuration example of the host computer 10000. The host computer 10000 includes a port 11000 for connection to the network 45000, a processor 12000, a storage resource 13000 (which may include a semiconductor memory or a disk device as a component), and an input and output device 14000, which are connected to one another via a circuit such as an internal bus.

A job application 13100 and an operating system 13200 are stored in the storage resource 13000.

The job application 13100 uses a storage area provided from the operating system 13200 and performs data input and output (hereinafter referred to as I/O) to and from the storage area.

The operating system 13200 executes processing for causing the job application 13100 to recognize, as storage areas, logical volumes on the storage apparatuses 20000 to 20010 connected to the host computer 10000 via the network 45000.

In FIG. 6, the port 11000 is represented as an I/O port for performing communication with the storage apparatus 20000 by iSCSI and a single port including a management port for the management server 30000 to acquire management information in the host computers 10000 to 10010. However, the port 11000 may be divided into the I/O port for performing communication by iSCSI and the management port.

<Internal Configuration of the Network Apparatus>

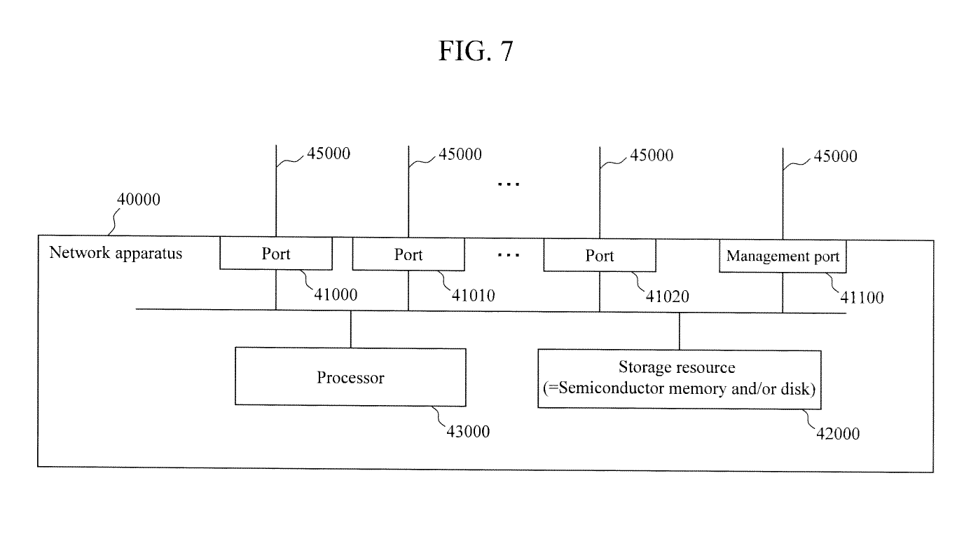

FIG. 7 is a diagram showing a detailed internal configuration example of the network apparatus 40000. A network apparatus 40010 has the same configuration.

The network apparatus 40000 includes I/O ports 41000 to 41020 for connection to the host computer 10000 or the storage apparatus 20000 via the network 45000, a management port 41100 for connection to the management server 30000 via the network 45000, a storage resource (a management memory) 42000 for storing various kinds of management information, and a processor 43000 for controlling data and management information in the management memory, which are connected to one another via a circuit such as an internal bus.

The network apparatuses 40000 and 40010 are, for example, IP switches and realize connection among the host computer 10000, the storage apparatus 20000, and the management server 30000.

<Internal Configuration of the Storage Apparatus>

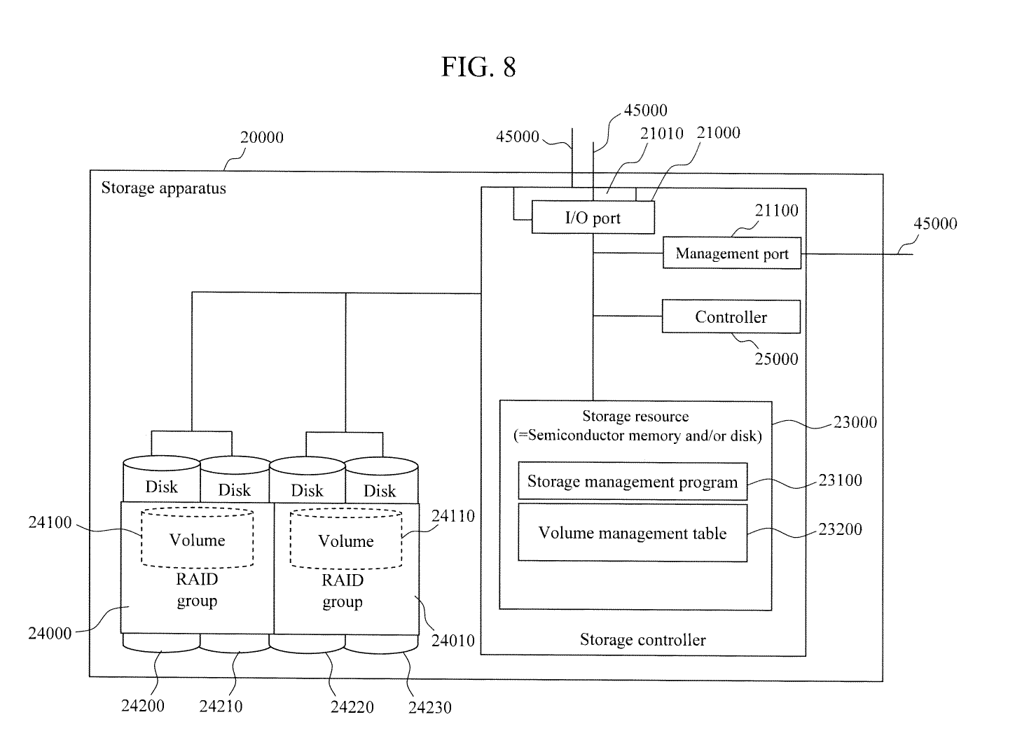

FIG. 8 is a diagram showing a detailed internal configuration example of the storage apparatus 20000. The storage apparatus 20010 has the same configuration.

The storage apparatus 20000 includes I/O ports 21000 and 21010 for connection to the host computer 10000 via the network 45000, a management port 21100 for connection to the management server 30000 via the network 45000, a storage resource (a management memory) 23000 for storing various kinds of management information, RAID groups 24000 and 24010 for storing data, and a controller 25000 for controlling data and management information in the management memory, which are connected to one another via a circuit such as an internal bus. The connection of the RAID groups 24000 and 24010 more accurately indicates that storage devices included in the RAID groups 24000 and 24010 are connected to other structures.

A management program 23100 for the storage apparatus and a volume management table 23200 for managing volumes of a magnetic disk are stored in the storage resource 23000. The management program 23100 communicates with the management server 30000 through the management port 21100 and provides the management server 30000 with configuration information of the storage apparatus 20000. The volume management table 23200 is a table for managing information indicating how the volumes are configured.

Each of the RAID groups 24000 and 24010 includes one or plural magnetic disks 24200, 24210, 24220, and 24230. When the RAID group includes plural magnetic disks, the magnetic disks may be formed in a RAID configuration. The RAID groups 24000 and 24010 are logically divided into plural volumes 24100 and 24110.

The logical volumes 24100 and 24110 do not have to be formed in a RAID configuration as long as the logical volumes 24100 and 24110 are configured by using storage areas of one or more magnetic disks. The logical volumes 24100 and 24110 may be storage devices including other storage media such as flash memories instead of the magnetic disks as long as storage areas corresponding to the logical volumes are provided.

The controller 25000 includes, on the inside thereof, a processor which performs control in the storage apparatus 20000 and a cache memory which temporarily stores data exchanged between the controller 25000 and the host computer 10000. The controller 25000 is interposed between an I/O port and a RAID group and performs exchange of data between the I/O port and the RAID group.

The storage apparatus 20000 may have a configuration other than the configuration shown in FIG. 8 and explained above as long as the storage apparatus 20000 includes a storage controller which provides any host computer with logical volumes, receives an access request (indicating an I/O request), and performs reading and writing to and from a storage device according to the received access request and the storage device which provides a storage area. For example, the storage controller and the storage device which provided the storage area may be stored in separate housings. In an example shown in FIG. 8, the storage resource 23000 and the controller 25000 are integrally provided as the storage controller. However, the storage resource 23000 and the controller 25000 may be configured as separate entities. In this specification, as an expression used when the storage controller and the storage device are present in the same housing or the separate housings are included, the storage apparatus may be read as a storage system.

<Internal Configuration of the Management Server (the Management Computer)>

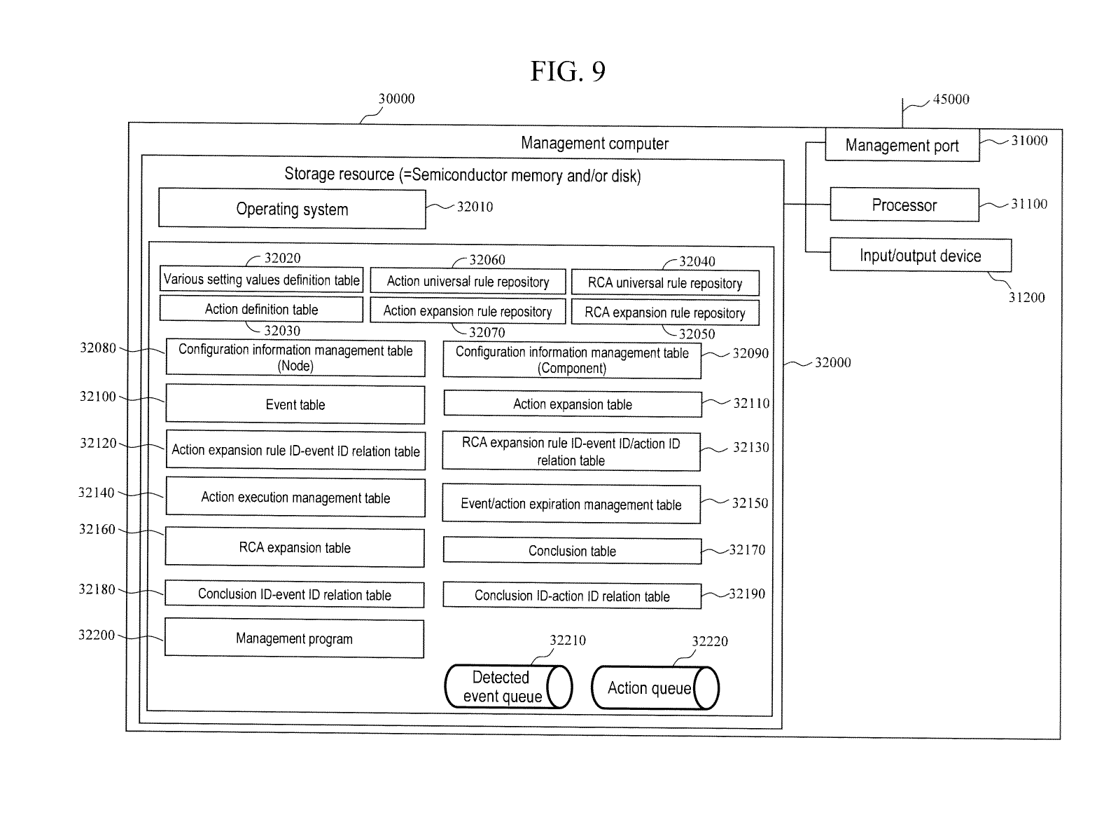

FIG. 9 is a diagram showing a detailed internal configuration example of the management server 30000. The management server 30000 includes a management port 31000 for connection to the network 45000, a processor 31100, a storage resource 32000 such as a semiconductor memory or a HDD, and an input/output device 31200 such as a display apparatus for outputting a processing result explained later and a keyboard for a storage administrator to input an instruction, which are connected to one another via a circuit such as an internal bus.

In the storage resource 32000, an operating system 32010, a various setting values definition table 32020, an action definition table 32030, an RCA universal rule repository 32040, an RCA expansion rule repository 32050, an action universal rule repository 32060, an action expansion rule repository 32070, a configuration-information-for-node management table 32080, a configuration-information-for-component management table 32090, an event table 32100, an action expansion rule table 32110, an action expansion rule ID-event ID relation table 32120, an RCA expansion rule ID-event ID/action ID relation table 32130, an action execution management table 32140, an event/action expiration management table 32150, an RCA expansion rule table 32160, a conclusion table 32170, a conclusion ID-event ID relation table 32180, a conclusion ID-action ID relation table 32190, a management program 32200, a detected event queue 32210, and an action queue 32220 are stored. Details of the various components stored in the storage resource 3200 are explained later with reference to the drawings. Contents of the components are briefly explained below.

The various setting values definition table 32020 is a table for managing setting values of information necessary for executing root cause analysis processing such as a monitoring interval for a monitoring target apparatus.

An action definition table 32030 is a table for defining content of an action for determining whether or not a condition event introduced anew in the present invention is satisfied.

The RCA universal rule repository 32040 stores a universal rule for a root cause analysis. The RCA expansion rule repository 32050 stores an expansion rule for the root cause analysis obtained by applying configuration information of monitoring target apparatuses to an RCA universal rule.

The action universal rule repository 32060 stores universal rules for actions. The action expansion rule repository 32070 stores an action expansion rule obtained by applying the configuration information of the monitoring target apparatuses to an action universal rule.

The configuration-information-for-node management table 32080 is a table for managing the configuration information of the monitoring target apparatuses (node apparatuses). The configuration-information-for-component management table 32090 is a table for managing configuration information of components of the node apparatuses.

The event table 32100 is a table for managing events occurring in the monitoring target apparatuses and components of the monitoring target apparatuses or states of the monitoring target apparatuses and the components.

The action expansion rule table 32110 is a table for managing a correspondence relation between a used action expansion rule and an executed action.

The action expansion rule ID-event ID relation table 32120 is a table for managing a relation concerning which action is executed when which event occurs (a relation between an action expansion rule and an event related thereto).

The RCA expansion rule ID-event ID/action ID relation table 32130 is a table for managing a relation concerning which RCA expansion rule is applied when which event and action occur (a relation between an RCA expansion rule and an event and an action related thereto).

The action execution management table 32140 is a table for managing execution states of respective actions and last execution results of the actions.

The event/action expiration management table 32150 is a table for managing states (valid or not) of a detected event and an executed action.

The RCA expansion rule table 32160 is a table for managing results of respective kinds of root cause analysis processing.

The conclusion table 32170 is a table for managing a root cause analysis result and a conclusion message corresponding thereto.

The conclusion ID-event ID relation table 32180 is a table for associating a conclusion ID and an event ID and managing conclusions and a detection state of an event.

The conclusion ID-action ID relation table 32190 is a table for associating a conclusion ID and an action ID and managing a relation between conclusions and an action execution result.

The management program 32200 is a program for executing the root cause analysis processing in this embodiment and realizing processing until presentation of an analysis result to an administrator.

The detected event queue 32210 is a queue for accumulating a detected (collected) event. The event table 32100 is updated on the basis of the detected event.

The action queue 32220 is a queue for accumulating actions determined to be executed according to the action expansion rule. For example, the actions are executed in order of input to the action queue 32220.

For example, the management server (the management computer) 30000 includes a keyboard, a pointer device, and the like as input devices and includes a display, a printer, and the like as output devices. However, the management server 30000 may include other apparatuses. It is also possible that a serial interface or an Ethernet interface is used as a substitute of the input and output device, a computer for display including a display, a keyboard, or a pointer device is connected to the interface, information for display is transmitted to the computer for display and information for input is received from the computer for display to perform display on the computer for display or an input is received to substitute input and display in the input and output device.

In this specification, in some cases, a set of one or more computers which manage the computer system (an information processing system) 1 and display the information for display is referred to as management system. When the management server 30000 displays the information for display, the management server 30000 is the management system. A combination of the management server 30000 and the computer for display (e.g., the WEB browser starting server 35000 shown in FIG. 5) is also the management system. Processing equivalent to that of the management server may be realized by plural computers for an increase in speed and improvement reliability of management processing. In this case, the plural computers (when the computer for display performs display, the computer for display is also included) are the management system.

<Various Setting Values Definition Table (TBL_PROPERTY)>

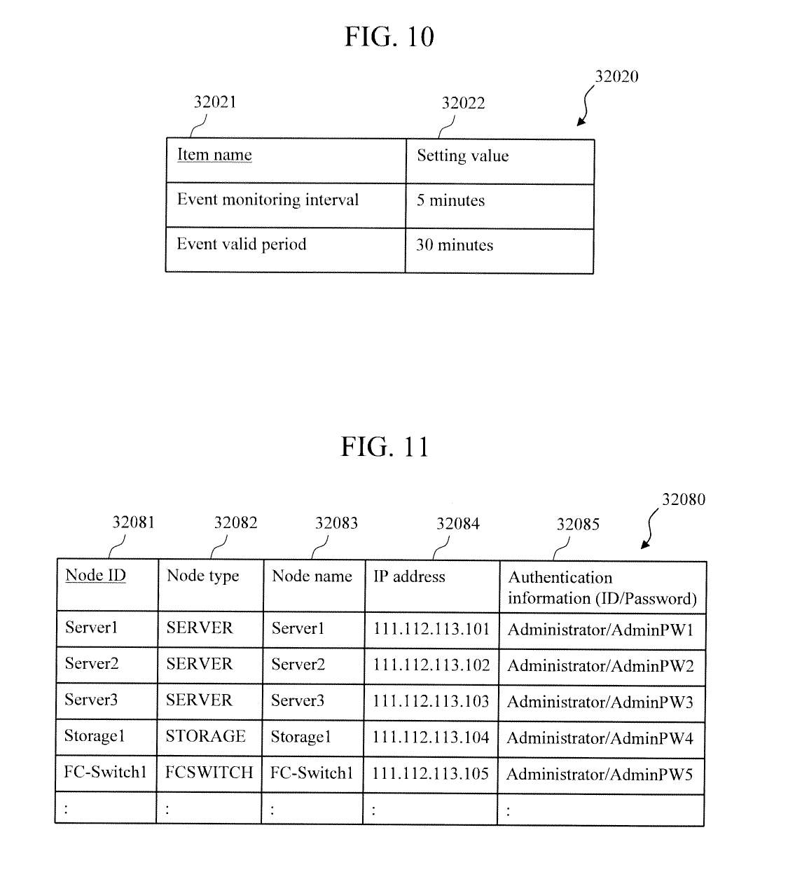

FIG. 10 is a diagram showing a structure example of the various setting values definition table 32020. The various setting values definition table 32020 includes an item name 32021 and a setting value 32022 as structure items. For example, as the item name 32021, an event monitoring interval and a valid period of an event acquired from the monitoring target apparatuses are included. The administrator can set the setting value 32022 as appropriate using the input/output device 31200 and can check whether the setting value 32022 is appropriately set.

In the example shown in FIG. 10, the event monitoring interval is set to 5 minutes and the event valid period is set to 30 minutes. In other words, information concerning events occurred in the monitoring target apparatuses is collected every 5 minutes and a valid period in which the collected event information can be used for the root cause analysis processing is 30 minutes. Items are not limited to those shown in FIG. 10. Items can be added according to necessity.

<Configuration-Information-for-Node Management Table (TBL_NODE)>

FIG. 11 is a diagram showing a structure example of the configuration-information-for-node management table 32080. The configuration-information-for-node management table 32080 includes information for managing configuration information of a monitoring target apparatus and includes, for example, a node ID 32081, a node type 32082, a node name 32083, an IP address 32084, and authentication information 32085 as structure items.

The node ID 32081 is identification information for specifying a monitoring target apparatus. The node type 32082 is information for specifying a type of the monitoring target apparatus. The node name 32083 is information indicating a name of the monitoring target apparatus. The IP address 32084 indicates an IP address used in accessing the monitoring target apparatus. The authentication information 32085 is information including, for example, an administrator ID and a password. And used for authentication processing executed when the management server 30000 accesses the monitoring target apparatus.

<Configuration-information-for-component management table (TBL_COMPO)>

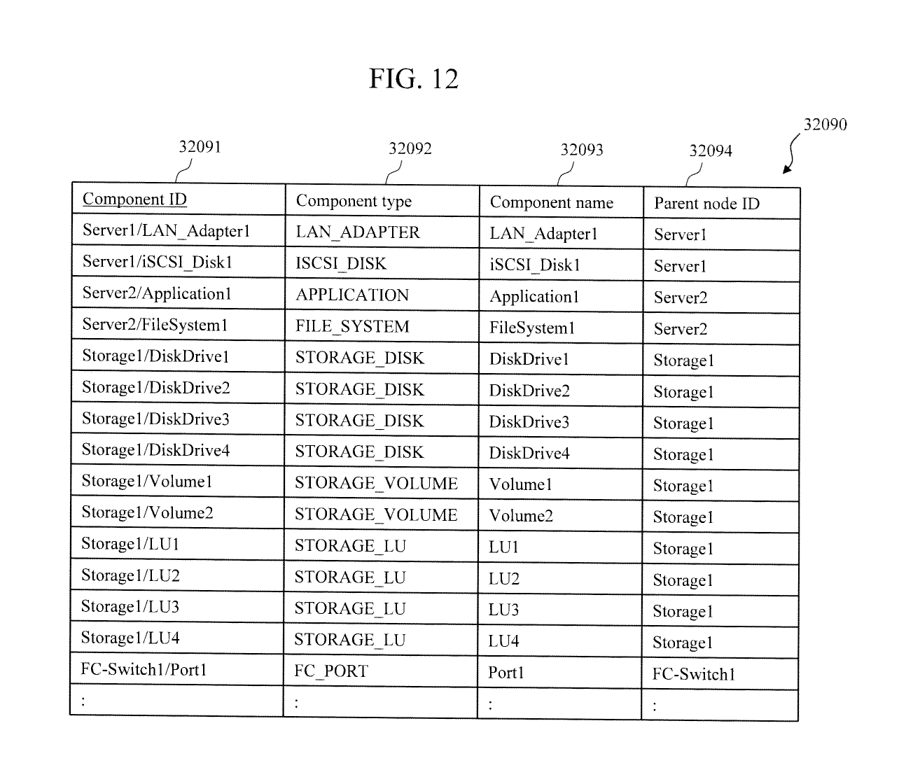

FIG. 12 is a diagram showing a structure example of the configuration-information-for-component management table 32090. The configuration-information-for-component management table 32090 includes information for managing information concerning components included in a monitoring target apparatus and includes, for example, a component ID 32091, a component type 32092, a component name 32093, and a parent node ID 32094 as structure items.

The component ID 32091 is identification information for specifying a component included in the monitoring target apparatus. The component type 32092 is information indicating a type of the component included in the monitoring target apparatus. The component name 32093 is information indicating a name of the component included in the monitoring target apparatus. The parent node ID is information indicating the monitoring target information including the component.

<RCA Universal Rule>

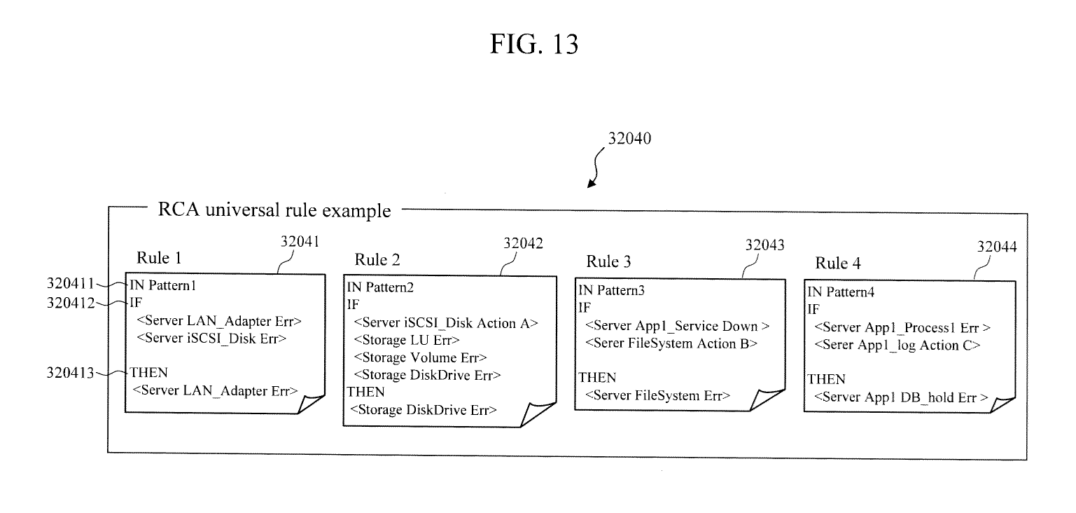

FIG. 13 is a diagram showing an example of the RCA universal rule stored in the RCA universal rule repository 32040. RCA universal rules (rules 1, 2, 3, 4, . . . ) 32041 to 32064 are defined in advance in an IN-IF-THEN format indicated by an IN clause 320411, an IF clause (in the following explanation, also referred to as IF part and condition part) 320412, and a THEN clause (in the following explanation, also referred to as THEN part and conclusion part) 320413.

The RCA universal rule and the action universal rule explained later are rules indicating a relation between a combination of one or more condition events which could occur in a monitoring target apparatus included in the computer system 1 and a conclusion event set as a failure cause with respect to the combination of the condition events. In other words, the RCA/action universal rules are rules indicating that, when an event occurs in the condition part, content described in the conclusion part could be a root cause of a failure.

In general, an event propagation model for specifying a cause in a failure analysis describes, in an “IN-IF-THEN” format, a combination of events predicted to occur as a result of a certain failure and a cause of the events. RCA/action universal rules are not limited to those shown in FIGS. 11 and 12 as the examples. More rules may be present.

The IN clause 320411 is information for specifying a type of a pattern for specifying, when the RCA universal rule is expanded, how the RCA universal rule is expanded.

The IF clause 320412 includes, as information concerning a condition event, a relation among nodes or components (nodes or components arranged according to conditions have a relation with one another), event or states detected in the respective nodes or components as conditions, or results obtained by executing an action defined in the action universal rule in the respective nodes.

The THEN clause 320413 indicates an event or a state of a node or a component as a conclusion (a root cause) when the events or the states indicated by the IF clause 320412 are detected or the execution results of the action are true.

For example, an RCA universal rule Rule-3 32043 indicates that “DiskDrive of Storage is an error” indicated by the THEN clause 320413 is a root cause at a certainty factor of the number of detected events/the number of condition events if, in a topology expanded in Pattern 7 designated by the IN clause 320411, any one of events “a result obtained by executing Action A in Server is true”, “an error in LU of Storage”, “an error in Volume of Storage”, and “an error in DiskDrive of Storage” indicated by the IF clause 320412 can be detected.

There is a relation that, if an event to the IF clause (the condition part) 320412 is detected, an event of the THEN clause (the conclusion part) 320413 is a root cause of a failure and, if a status of the THEN clause 320413 is normal, a problem of the IF clause 320412 is solved.

<Action Universal Rule>

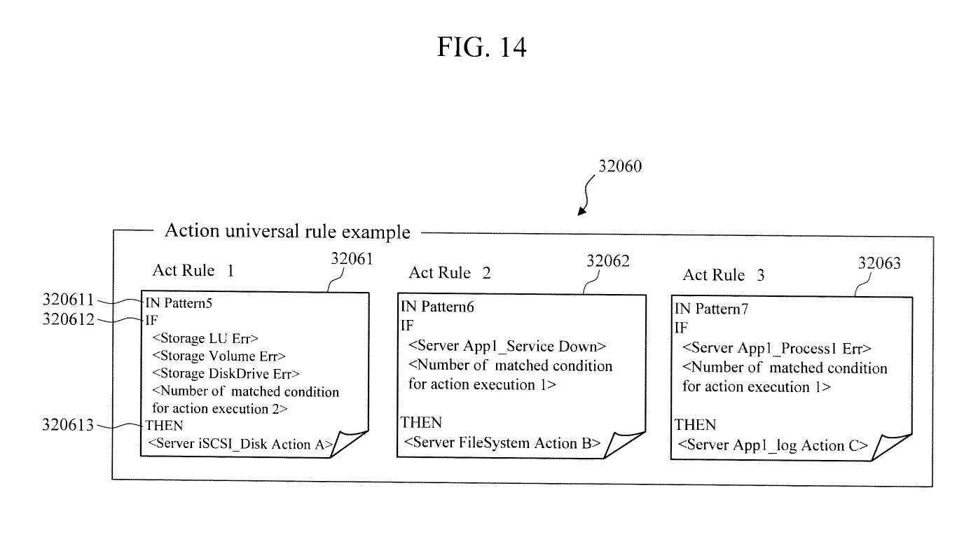

FIG. 14 is a diagram showing an example of the action universal rule stored in the action universal rule repository 32060. Action universal rules (rules 1, 2, 3, 4, . . . ) 32061 to 32063 are defined in advance in an IN-IF-THEN format indicated by an IN clause 320611, an IF clause 320612, and a THEN clause 320613.

The IN clause 320611 is information for specifying a type of a pattern for specifying, when the action universal rule is expanded how the action universal rule is expanded. An expansion pattern name separately defined is shown.

The IF clause 320612 includes, as information concerning a condition event for action execution, a relation among nodes or components (nodes or components arranged according to conditions have a relation with one another), events or states detected in the respective nodes or components as conditions, or the number of detected events or the number of detected states necessary for execution of an action.

The THEN clause 320613 indicates an action executed when the events or the states included in the IF clause 320612 are detected by a number necessary for execution of the action.

for example, an action universal Rule-1_32061 indicates that “execute Action A in Server” indicated by the THEN clause 320613 if, in a topology expanded in Pattern 5 designated in the IN clause 320611, two or more of events or states of “an error in LU of Storage”, “an error in Volume of Storage”, and “an error in DiskDrive of Storage” indicated by the IF clause 320612 are detected.

A result of the action executed according to the action rule is included in the condition part of the RCA rule. The management server 30000 creates an RCA expansion rule and an action expansion rule from a configuration information management table and universal topology information (e.g., Server(LAN_ADAPTER)-Server(iSCSI_DISK) and Server(ScsiDiskDrive)-Storage(STORAGE_LU)-Storage(STORAGE_VOLUME)-Storage(STORAGE_DISK)) included in the RCA universal rule and the action universal rule.

<Creation of an Expansion Rule>

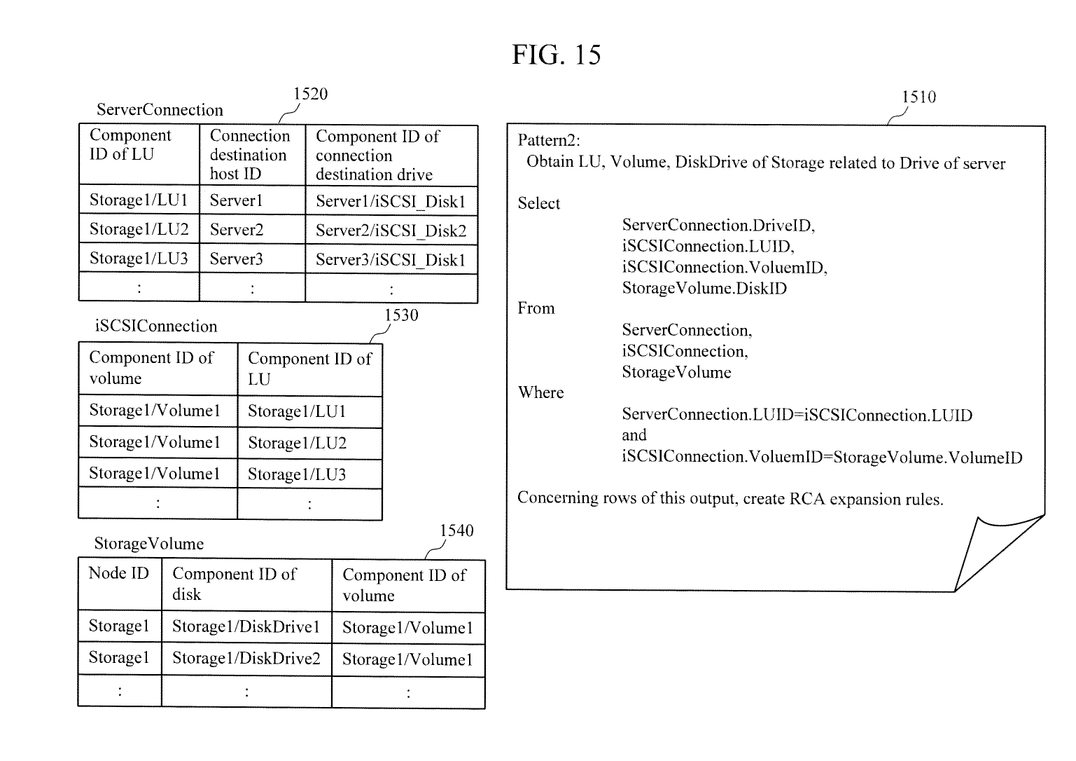

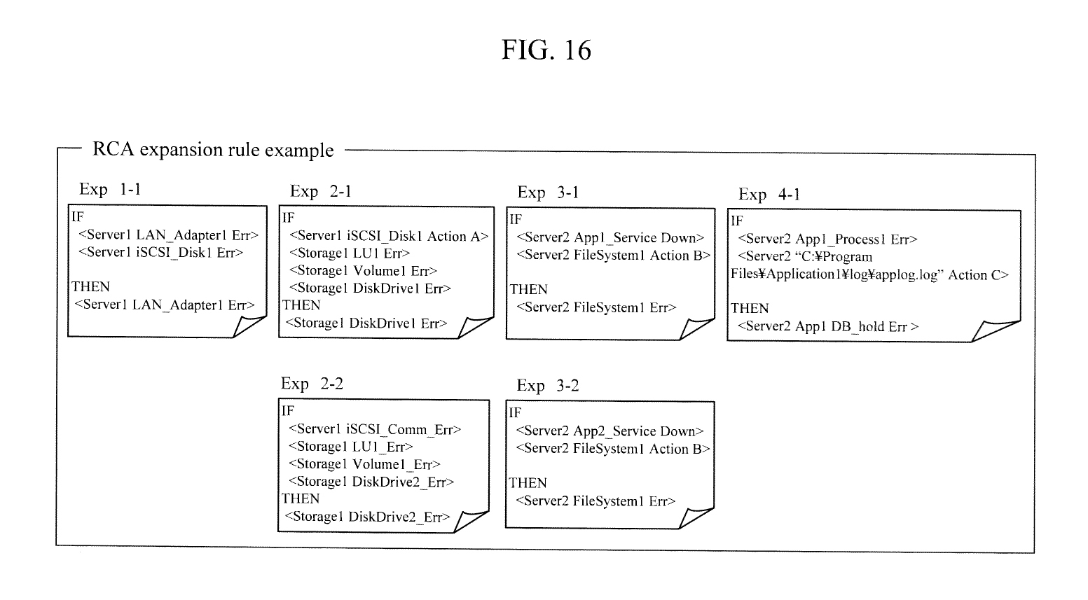

FIG. 15 is a diagram showing an example of a component attribute information table and an expansion pattern (a rule expansion topology) used for expanding the RCA universal rule. A method of expanding an RCA universal rule 2_32042 and generating an RCA expansion rule 2 (Exp 2-1 and Exp 2-2 shown in FIG. 16) is explained with reference to FIG. 15.

A pattern 2_1510 indicates a procedure for obtaining LU, Volume, and DiskDrive of a Storage related to a Drive of a Server and is used for expansion of the RCA universal rule 2_32042. In FIG. 15, a Server Connection Table 1520, an iSCSI Connection table 1S30, and a Storage Volume table 1540 are generated during information collection for apparatuses.

It is seen from the Server Connection table 1520 shown in FIG. 15 that Storage1/LU1 is associated with Server1/iSCSI_Disk1. It is seen from the iSCSI Connection table 1S30 that Storage1/LU1 is associated with Storage1/Volume1. Further, it is seen from the Storage Volume table 1540 that Storage1/Volume1 is associated with Storage1/DiskDrive1 and Storage1/DiskDrive2.

In this way, an expansion rule indicating whether or not an execution result of the Action A is satisfied and in which Disk of which Server, an error in which LU of which Storage, an error in which Volume in which Storage, and an error in which DiskDrive in which Storage are condition events and an error in which DiskDrive of which Storage is set as a root cause is derived.

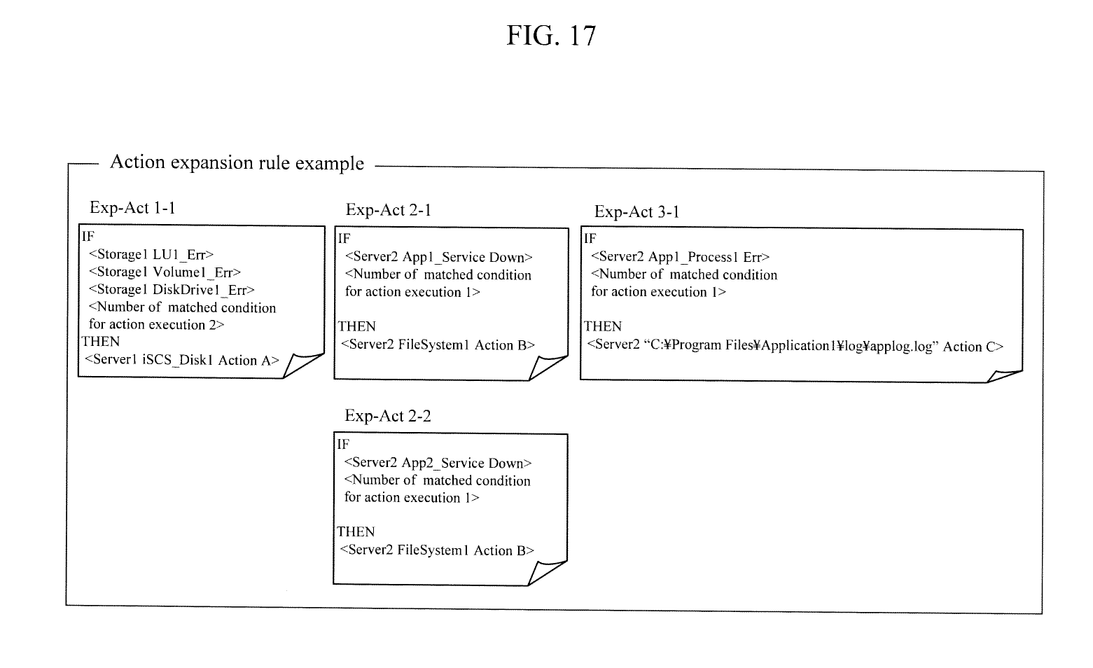

Therefore, the RCA expansion rules Exp 2-1 and Exp 2-2 are generated from the RCA universal rule 2_32042 (see FIG. 16). Expansion rules are output in the same manner concerning other RCA universal rules and action universal rules (see FIGS. 16 and 17).

<RCA Expansion Rule>

FIG. 16 is a diagram showing an example of an RCA expansion rule stored in the RCA expansion rule repository 32070.

As explained with reference to FIG. 15, the RCA expansion rule is generated by applying, according to pattern information (e.g., the pattern 2_1510) used in the IN clause 320411 and separately defined, collected configuration information of monitoring target apparatuses and components thereof to an RCA universal rule. Like EXP2-1, EXP2-2, EXP3-1, and EXP3-2, in some cases, plural RCA expansion rules are generated from one RCA universal rule.

For example, the RCA expansion rule of EXP 2-1 shown in FIG. 16 is generated by expanding the RCA universal rule 2_32042. In this RCA expansion rule of EXP 2-1, it is seen that, when four events of whether or not an execution result of the action A is satisfied in Disk1 of Server1, an error in LU1 of Storage1, an error in Volume1 of Storage1, and an error of DiskDrive1 of Storage1 are detected as observation events (condition events), the error in DiskDrive1 of Storage1 is concluded as a root cause of a failure.

<Action Expansion Rule>

FIG. 17 is a diagram showing an example of an action expansion rule stored in the action expansion rule repository 32050.

In the same manner as the RCA expansion rule, the action expansion rule is generated by applying, according to the pattern information used in the IN clause 320611 and separately defined, collected configuration information of monitoring target apparatuses and components thereof to an action universal rule. Like EXP-Act 2-1 and EXP-Act 2-2, in some cases, plural action expansion rules are generated from one action universal rule.

For example, an action expansion rule of Exp-Act 1-1 shown in FIG. 17 is generated by expanding the action universal rule 1_32061. In this action expansion rule of Exp-Act 1-1, it is seen that, when two or more of occurrence of an error in LU1 of Storage1, occurrence of an error in Volume1 of Storage1, and occurrence of an error of DiskDrive1 of Storage1 are detected as observation events (condition events), Drive1 of Server1iSCSI is controlled to execute the action A defined in an action table explained later.

<Event Table (TBL_EVT)>

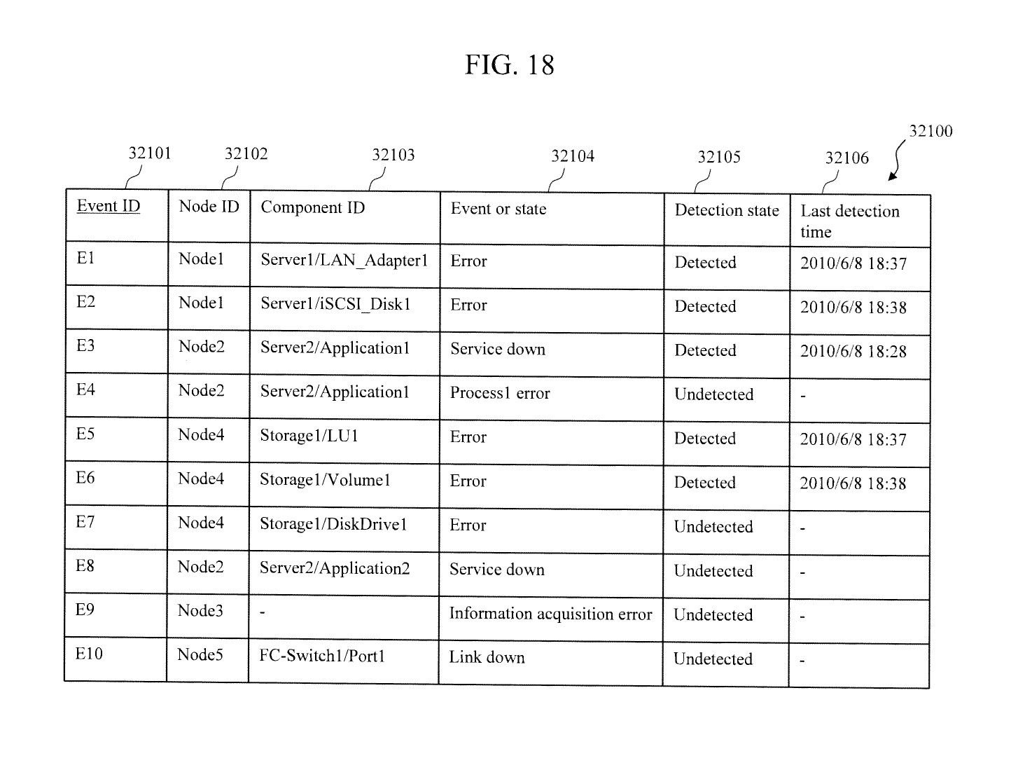

FIG. 18 is a diagram showing a structure example of the event table 32100. After being started, the management server 30000 periodically collects events or states from a monitoring target apparatus (a node or a component) and stores detection states and last detection times of the events or the states in the event table 32100 (event collection processing).

The event table 32100 includes an event ID 32101, a node ID 32102, a component ID 32103, an event or state 32104, a detection state 32105, and a last detection time 32106 as structure items. In the event table 32100, the event ID 32101, the node ID 32102, the component ID 32103, and the event or state 32104 are fixed information input from the beginning. The detection state 32105 indicating whether events (E1 to E10; all assumed events are listed up) are detected by the event collection processing and the detection time 32106 of the detection state 32105 are input. If the events are detected, the detection state 32105 is changed from undetected to detected.

In this embodiment, an example of types of events or states of the monitoring target apparatus is as explained below. The events means specific events concerning what occurred in which component and when as explained below. The states of the monitoring target apparatus may be states of the monitoring target apparatus or may be states of a component.

(i) Events

(a) States of the monitoring target apparatus (which may be referred to as node), a component (a hardware component) included in the monitoring target apparatus, a software component such as a program to be executed, or a component (a logical component) logically generated by processing of the hardware component or/and the software component have changed. In the following explanation, when the hardware component, the software component, and the logical component are not distinguished, the components are simply referred to as component.

(b) Processing/state different from normal processing/state has occurred in the node or the component.

(ii) States

An example of the states of the monitoring target apparatus is as explained below.

(a) Possibility of normal operation of the component. In other words, this may be a state indicating presence or absence of occurrence of a failure in the component.

(b) A measurement value (metric) concerning the component. For example, the temperature of the component or a processing amount (IOPS), the number of transactions of a database, a transfer data amount per unit time, etc.) processed by the component per unit time. When the state is considered as an event, in some cases, occurrence of an event is considered on the basis of the metric and a threshold.

Action definition table (TBL_ACT_DEF)>

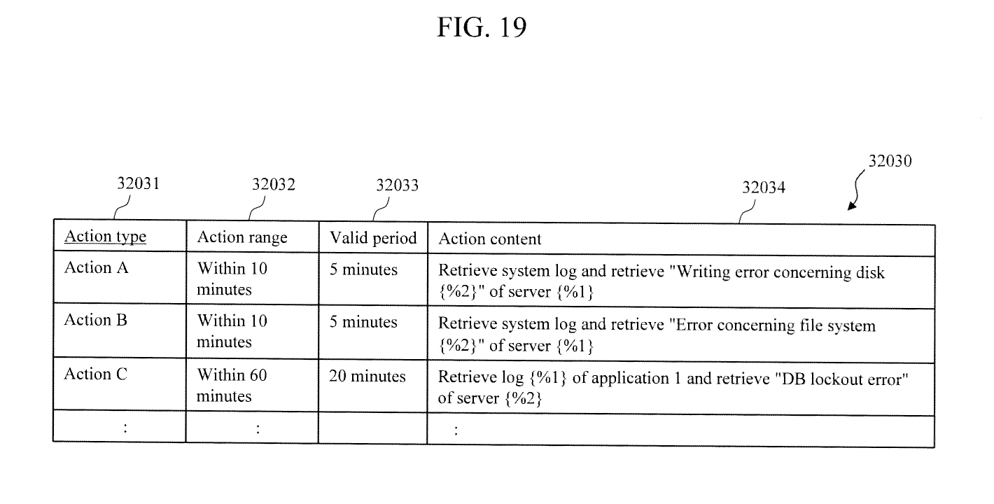

FIG. 19 is a diagram showing a structure example of the action definition table 32030. The action definition table 32030 includes an action type 32031, an action range 32032, a valid period 32033, and action content 32034 as structure items.

The action type 32031 is an item for specifying a type of an action (an action name). The action range 32032 is an item for specifying in which range of time in the past from a point of action execution detection a system log is retrieved. The valid period 32033 is an item for specifying in which length of time after a relevant action execution result is obtained the same execution result is used as an action execution result (without actually executing an action). The action content 32034 defines content which should be executed concerning an action corresponding to the action type 32031. {%1} and {%2} are arguments and are replaced with parameter values designated during action execution.

For example, in FIG. 19, the action A has content indicating that, when execution of the action A is determined, a system log of a disk of a monitoring target server within 10 minutes in the past from the point of the determination is retrieved and it is determined whether a writing error is present. When an execution command for the action A is issued within 5 minutes after acquisition of a result of the execution, the same action execution result is used as a determination result with respect to the execution command,

<Action Execution Management Table (TBL_ACT)>

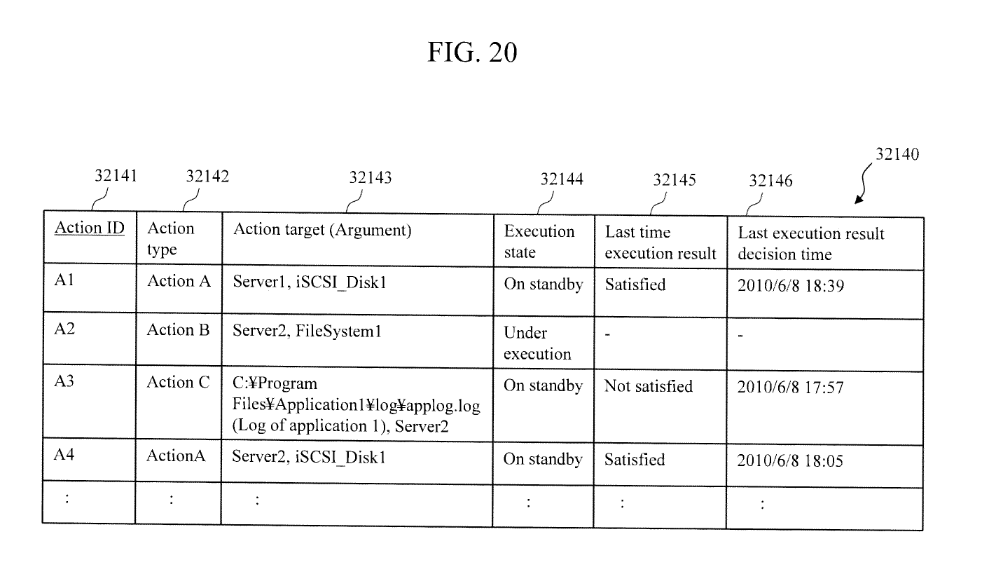

FIG. 20 is a diagram showing a structure example of the action execution management table 32140. The action execution management table 32140 includes an action ID 32141, an action type 32142, an action target 32143, an execution state 32144, a last time execution result 32145, and a last execution result decision time 32146 as structure items. The items of the action ID 32141, the action type 32142, and the action target 32143 are fixed and information concerning the items is input from the beginning. Information concerning the execution state 32144, the last time execution result 32145, and the last execution result decision time 32146 are blank in the beginning. The information is inserted and sequentially changed as processing proceeds.

The action ID 32141 is identification information for specifying an action. As in the action definition table 32030 (FIG. 18), the action type 32142 is an item for specifying a type of an action (an action name). The action target (an argument) 32143 is information indicating a monitoring target apparatus and a component input to the arguments ({%1} and {%2}) of the action content 32034 of the action definition table 32030. The execution state 32144 is information indicating execution states of actions, i.e., whether the actions are on standby or under execution. The last time execution result 32145 is information indicating an action execution result obtained when an action is executed on the same action target as the last time. The last execution result decision time 32146 is information indicating time when an execution result of the last time is decided. For example, in FIG. 20, concerning A1 in the action ID 32141, it is seen that the action A is executed on iSCSI_Disk1 of the server 1, the execution state 32144 of the action A is “on standby”, the execution result of the last time is satisfaction of the action A (a writing error in iSCSI_Disk1 of the server 1 is detected from a system log), and decision time of the execution result is Jun. 8, 2010, 18:39.

The management server 30000 stores a relation between an action to be executed and an execution target of the action in an action table in advance on the basis of an action expansion rule. The management server 30000 manages an execution state of the action in the action execution management table 32140.

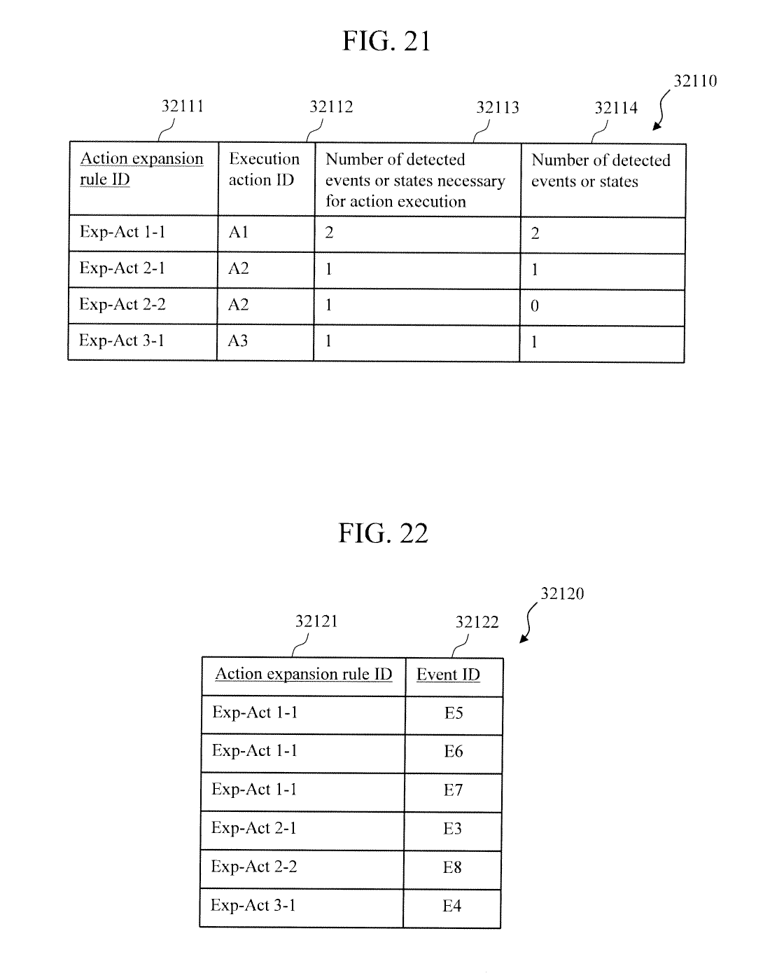

The action is executed when events equivalent to the number of detected events defined in the action expansion rule are detected as shown in an action expansion rule table (FIG. 21) explained later. When an action execution request is made according to a certain action expansion rule, if the action is already being executed, the action is not redundantly executed and a result of the action being executed earlier is diverted. When a certain action is executed according to plural action rules, if events reach the number of detected events in one action expansion rule, the action is executed. Therefore, an action of another action expansion rule, for which events do not reach the number of detected events, is also executed.

As explained above, the action execution management table 32140 stores the last time execution result (a recent execution result) 32145 of an action. When an execution request for a certain action is made, if the action is executed within time in a retrieval range defined for the action, a result of an executed action is diverted. For example, in the action execution management table 32140, it is assumed that an execution request for A3 in the action ID 32141 is made at 2010/6/8 18:10. A valid period of an action C executed in A3 is 20 minutes and result decision time of the last time execution is 2010/6/8 17:57 (within 20 minutes), A3 is not executed again and a last time execution result is used.

<Action Expansion Rule Table (TBL_EXP_ACT)>

FIG. 21 is a diagram showing a structure example of the action expansion rule table 32110. The action expansion rule table 32110 is a table directly obtained from action expansion rules. Information used in determining whether an action is executed is managed in the action expansion rule table 32110.

The action expansion rule table 32110 includes an action expansion rule ID 32111, an execution action ID 32112, a number of detected events or states necessary for action execution 32113, a number of detected events or states 32114 as structure items.

The action expansion rule ID 32111 is identification information for specifying action expansion rules. The execution action ID 32112 is identification information for specifying actions which should be executed according to the action expansion rules. The number of detected events or states necessary for action execution 32113 is information indicating how many events or states indicated by IF clauses of the action expansion rules should be present in the event table 32100 when the action is executed. The number of detected events or states 32144 is information indicating the number of detected events or states indicated by the IF clauses of the action expansion rules in the event table 32100.

For example, in Exp-Act 1-1, it is indicated that the number of events necessary for action execution is two and two events are currently detected. In Exp-Act 2-2, it is indicated that the number of events necessary for action execution is one but no event is currently detected. Therefore, it is seen that an action A1 is executed concerning Exp-Act 1-1 and an action A2 is not executed concerning Exp-Act 2-2.

<Action Expansion Rule ID-Event ID Related Table (TBL_ACT_EVT)>

FIG. 22 is a diagram showing a structure example of the action expansion rule ID-event ID relation table 32120. The action expansion rule ID-event ID relation table 32120 is a table for managing action expansion rules and events related thereto and includes an action expansion rule ID 32121 and an event ID 32122 as structure items. The table is also a table directly obtained from an action expansion rule.

The action expansion rule ID 32121 is identification information for specifying the action expansion rules. The event ID 32122 is identification information for specifying events related to the action expansion rules. The action expansion rule ID corresponds to the identification information (Exp-Act 1-1, Exp-Act 2-1, etc.) of the action expansion rules stored in the action expansion rule repository 32070. The event ID 32122 corresponds to the event ID 32101 of the event table 32100.

It is seen from the action expansion rule ID-event ID relation table 32120 that, for example, events E5, E6, and E7 are related to the action expansion rule Exp-Act 1-1 as condition events.

<RCA Expansion Rule ID-Event ID/Action ID Relation Table (TBL_RCA_EVT_ACT)>

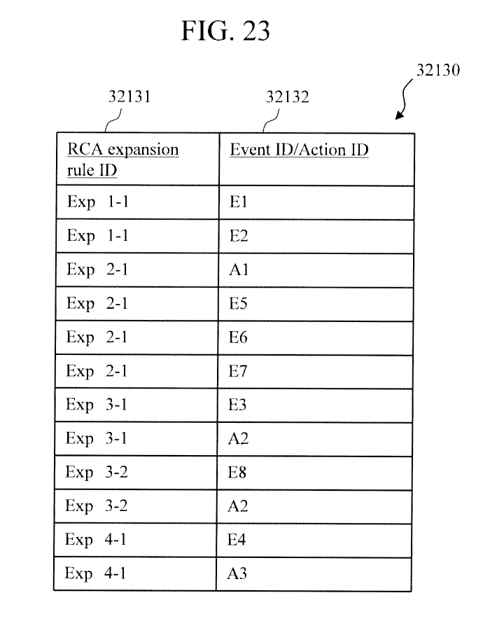

FIG. 23 is a diagram showing a structure example of the RCA expansion rule ID-event ID/action ID relation table 32130. The RCA expansion rule ID-event ID/action ID relation table 32130 is a table for managing RCA expansion rules and events and actions related thereto and includes an RCA expansion rule ID 32131 and an event ID/action ID 32132 as structure items. The table is a table directly obtained from an RCA expansion rule.

The RCA expansion rule ID 32131 is identification information for specifying RCA expansion rules. The event ID/action ID 32132 is identification information for specifying events and actions related to the RCA expansion rules. The RCA expansion rule ID corresponds to the identification information (Exp 1-1, Exp 2-1, etc.) of the RCA expansion rules stored in the RCA expansion rule repository 32050. The event ID/action ID 32132 corresponds to the event ID 32101 of the event table 32100 and the action ID 32141 of the action execution management table 32140.

It is seen from the RCA expansion rule ID-event ID/action ID relation table 32130 that, for example, the action A1 and the events E5, E6, and E7 are related to the RCA expansion rule Exp 2-1 as condition events.

<Event/Action Expiration Management Table (TBL_EVT_ACT_EXPIRATION)>

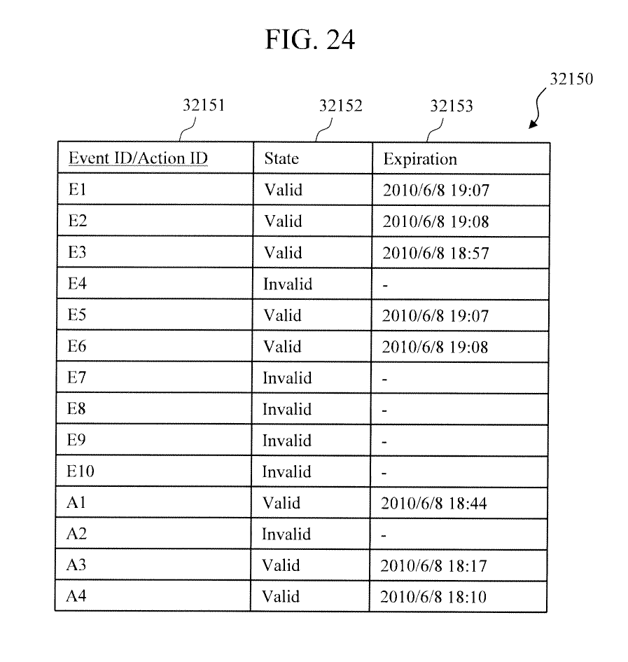

FIG. 24 is a diagram showing a structure example of the event/action expiration management table 32150. The event/action expiration management table 32150 is a table for managing expiration of a detected event or an action and includes an event ID/action ID 32151, a state 32152, and expiration 32513 as structure items.

The event ID/action ID 32151 is identification information for specifying an event and an action included in an RCA expansion rule and an action expansion rule. All events and actions are stored in the item.

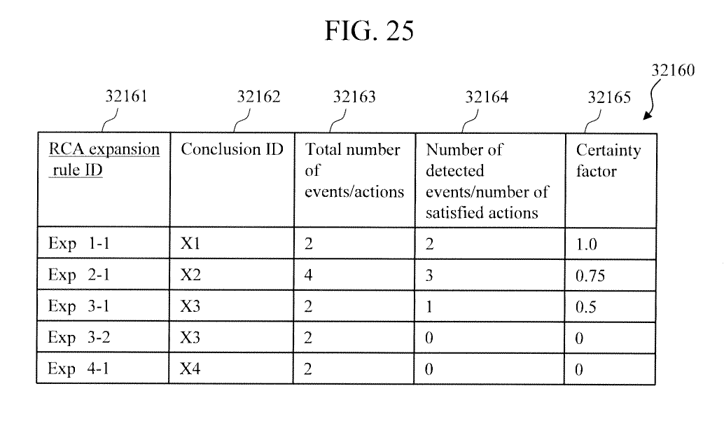

The state 32152 indicates whether detected events and actions are valid or invalid. Besides expired events and actions, states of undetected events and actions are managed as invalid. When there is a change in this state 32152, the management server 30000 (the management program 32200) increases or reduces the number of detected events/number of satisfied actions 32164 in the RCA expansion rule table 32160 explained later (see FIG. 25). For example, when an event and an action are expired and states are changed from valid to invalid, the management program 32200 reduces the number of detected events/number of satisfied actions 32164 of an RCA expansion rule corresponding to the event and the action. When satisfaction of an event and an action is detected and states are changed from invalid and valid, the management program 32200 increases the number of detected events/number of satisfied actions 32164 of an RCA expansion rule corresponding to the event and the action by one.

The expiration 32153 is information indicating expiration of an event and an action. Concerning an event, this expiration 32153 is time obtained by adding an event valid period (e.g., 30 minutes) of the various setting values definition table 32020 to time when event satisfaction is detected. Concerning an action, the expiration 32153 is time obtained by adding each valid period 32033 (e.g., 5 minutes or 20 minutes: the valid period is different depending on a type of an action) defined in the action definition table 32030 at time when action satisfaction is detected.

Unless a root cause is dealt with and solved, every time event monitoring is performed, event or action satisfaction corresponding to the event monitoring is detected. In this case, in the event/action expiration management table 32150, the state 32152 is kept valid and the expiration is managed to be extended.

<RCA Expansion Rule Table (TBL_RCA)>

FIG. 25 is a diagram showing a structure example of the RCA expansion rule table 32160. The RCA expansion rule table 32160 is a table for managing analysis results of RCA expansion rules and includes an RCA expansion rule ID 32161, a conclusion ID 32162, a total number of events/actions 32163, a number of detected events/number of satisfied actions 32164, and a certainty factor 32165 as structure items.

The RCA expansion rule ID 32161 is identification information for specifying an RCA expansion rule. In the item, all the RCA expansion rules included in the RCA expansion rule repository 32050 are stored.

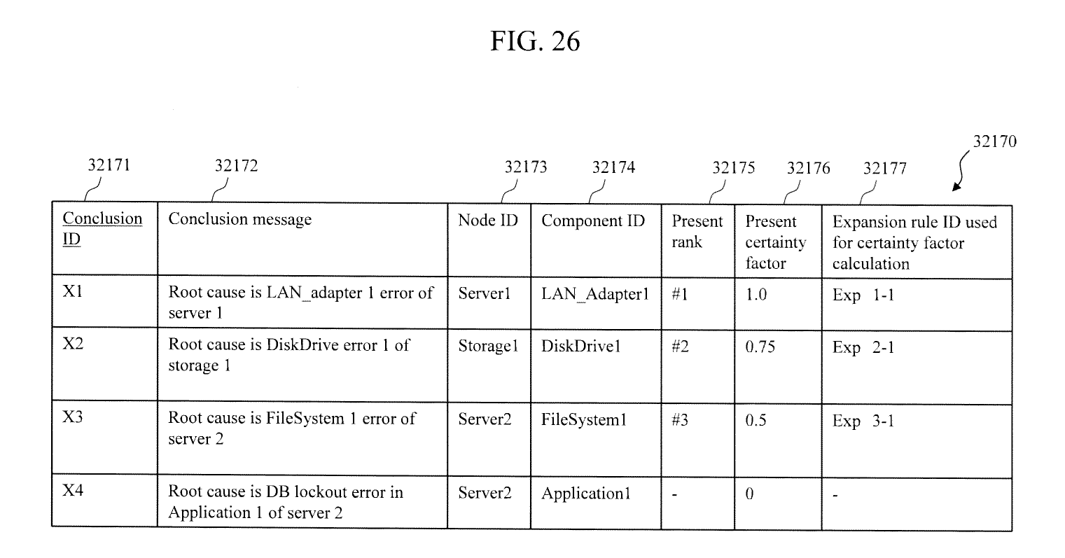

The conclusion ID 32162 is identification information for specifying THEN clauses (conclusion parts) of RCA expansion rules. Content of a conclusion (a root cause) corresponding to the conclusion ID 32162 is shown in the conclusion table 32170 explained later (FIG. 26).

The total number of events/actions 32163 is information indicating a total number of condition events and actions included in IF clauses (condition parts) of the RCA expansion rules.

The number of detected events/number of satisfied actions 32164 is infatuation indicating a sum of the number of events and the number of satisfied actions among condition events and actions included in the IF clauses of the expansion rules.

The certainty factor 32165 is information indicating accuracy of an RCA analysis result, in other words, a degree of a program (a trouble) and is obtained by dividing the number of detected events/number of satisfied actions 32164 by the total number of events/actions 32163. This certainty factor 32165 indicates at which level of accuracy a relevant trouble cause could be a root cause.

In FIG. 25, for example, it is seen that, in the RCA expansion rule Exp 2-1, the certainty factor 32165 is ¾=0.75 in a certain monitoring period because satisfaction of three events and actions among four condition events (the total number of events/actions 32162) included in an expansion rule.

Item values of the RCA expansion rule ID 32161, the conclusion ID 32162, and the total number of events/actions 32163 are fixed. Item values of the number of detected events/number of satisfied actions 32164 and the certainty factor 32165 fluctuate.

<CONCLUSION Table (TBL_ROOT_CAUSE>

FIG. 26 is a diagram showing a configuration example of the conclusion table 32170. The management server 30000 stores a conclusion used in an RCA result as the conclusion table 32170. The conclusion table 32170 is a table for storing information concerning a conclusion used in an RCA result and includes a conclusion ID 32171, a conclusion message 32172, a node ID 32173, a component ID 32174, a present rank 32175, a present certainty factor 32176, and an expansion rule ID used for a certainty factor calculation 32177 as structure items. For example, a GUI presented to the administrator is generated on the basis of this table.

The conclusion ID 32171 is identification information for specifying a conclusion used in an RCA result. Identification information of all conclusions to be used (which present by a number equivalent to types of THEN part of an expansion rule) is stored in the item.

The conclusion message 32172 is information obtained by converting content of a THEN clause (a conclusion part) of an RCA expansion rule into a message and is present by a number equivalent to types of a THEN clause of an expansion rule.

The node ID 32173 is identification information for specifying a monitoring target apparatus in which a root cause of a failure is present included in a conclusion corresponding to the node ID 32173.

The component ID 32174 is identification information for specifying a component in which a root cause of a failure is present included in a conclusion corresponding to the component ID 32174.

The present rank 32175 is information indicating priority of a failure which should be dealt with. For example, a rank is determined in order from a failure with a highest certainty factor.

The certainty factor 32176 is information indicating a certainty factor calculated by root cause analysis (RCA) processing. For example, after the RCA expansion table 32165 is generated, the certainty factor 32176 is inserted into the conclusion table 32170.

The expansion rule ID 32177 used for a certainty factor calculation is information for specifying all RCA expansion rules used in calculating a certainty factor leading to a conclusion corresponding to the expansion rule ID 32177. An RCA expansion rule stored in the item space is not limited to one. Identification information of all RCA expansion rules leading to the same conclusion is stored in the item space. However, when plural certainty factors are obtained from plural RCA expansion rules, a value of a maximum certainty factor is stored.

<Conclusion ID-Event ID Relation Table (TBL_ROOT_CAUSE_EVT)>

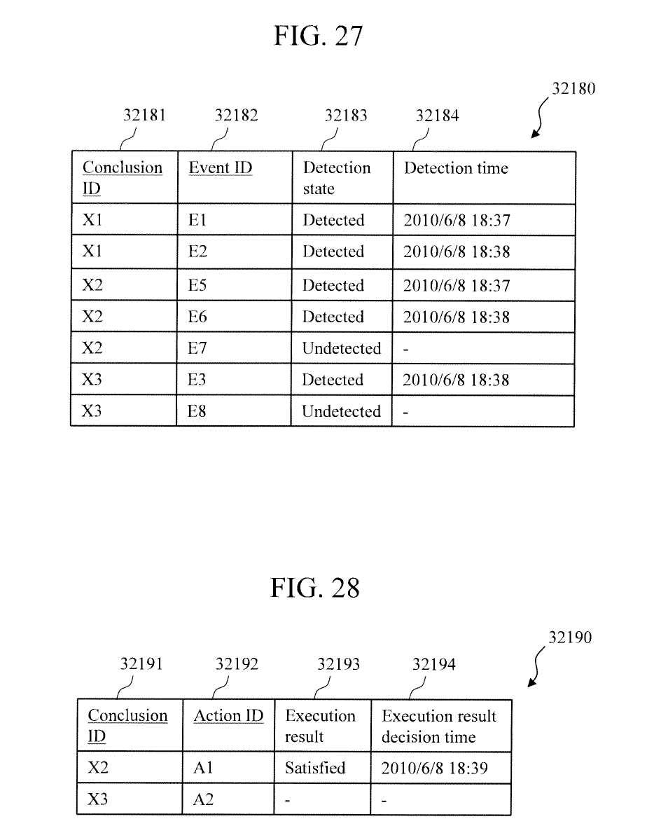

FIG. 27 is a diagram showing a structure example of the conclusion ID-event ID relation table 32180.

The conclusion ID-event ID relation table 32180 is a table for managing a relation between a conclusion and a detection state of an event and includes a conclusion ID 32181, an event ID 32182, a detection state 32183, and a detection time 32184 as structure items.

The conclusion ID 32181 is identification information for specifying conclusions corresponding to all condition events (excluding actions) included in an RCA expansion rule. When there are plural condition events included in the same RCA expansion rule, only the number of condition events having the same conclusion is stored in the item space.

The event ID 32182 is information indicating all events included in the RCA expansion rule.

The detection state 32183 is information indicating detection states of events. A state is determined on the basis of the detection state 32105 of the event table 32100. In an initial state, in this detection state 32183, all states are set to undetected. When an event is detected, the setting is changed to “detected.”

The detection time 32184 indicates time when events are detected.

<Conclusion ID-Action ID Relation Table (TBL_ROOT_CAUSE_ACT)>

FIG. 28 is a diagram showing a structure example of the conclusion ID-action ID relation table 32190. The conclusion ID-action ID relation table 32190 is a table for managing a relation between a conclusion and an execution result of an action and includes a conclusion ID 32191, an event ID 32192, an execution result 32193, and a detection time 32194 as structure items.

The conclusion ID 32191 is identification information for specifying conclusions corresponding to all actions as condition events included in an RCA expansion rule. Since actions are not always included in all RCA expansion rules as condition events, not all conclusions are stored in the item space.

The action ID 32191 is information indicating all the actions included in the RCA expansion rule.

The execution result 32193 is information indicating execution results of the actions. Content of the execution results is satisfied, not satisfied, or unexecuted (−).

The execution result decision time 32194 indicates time when an execution result of an action is decided.

<Management Program>

The management program 32200 is a program for executing management of a management target apparatus including, for example, configuration information management processing, event collection processing, collected (detected) event processing, action execution processing, expiration management processing, and GUI processing.

The configuration information management processing is processing for transmitting a configuration information acquisition request to monitoring target apparatuses and storing configuration information (node configuration information and component configuration information) returned from the monitoring target apparatuses respectively in the configuration-information-for-node management table 32080 and the configuration-information-for-component management table 32080.

The event collection processing is processing for collecting information concerning events or states detected from the monitoring target apparatuses.

The event collection processing is processing for collecting events occurred within a predetermined period (e.g., within an event monitoring time interval) from the monitoring target apparatuses.

The event collection processing is processing for determining an RCA expansion rule to which the events collected by the event collection processing is applied and calculating a certainty factor on the basis of the number of condition events, the number of detected events, and the number of satisfied actions in the RCA expansion rule. The collected event processing is processing for determining, on the basis of the detected events, whether an action specified in the RCA expansion rule is executed.

The action execution processing is processing for applying, when execution of an action is determined by the collected event processing, the detected events to an action expansion rule to execute the action and determining whether or not the action is satisfied.

The expiration management processing is processing for determining whether a collected (detected) event and a satisfied action expires and invalidating expired event and action.

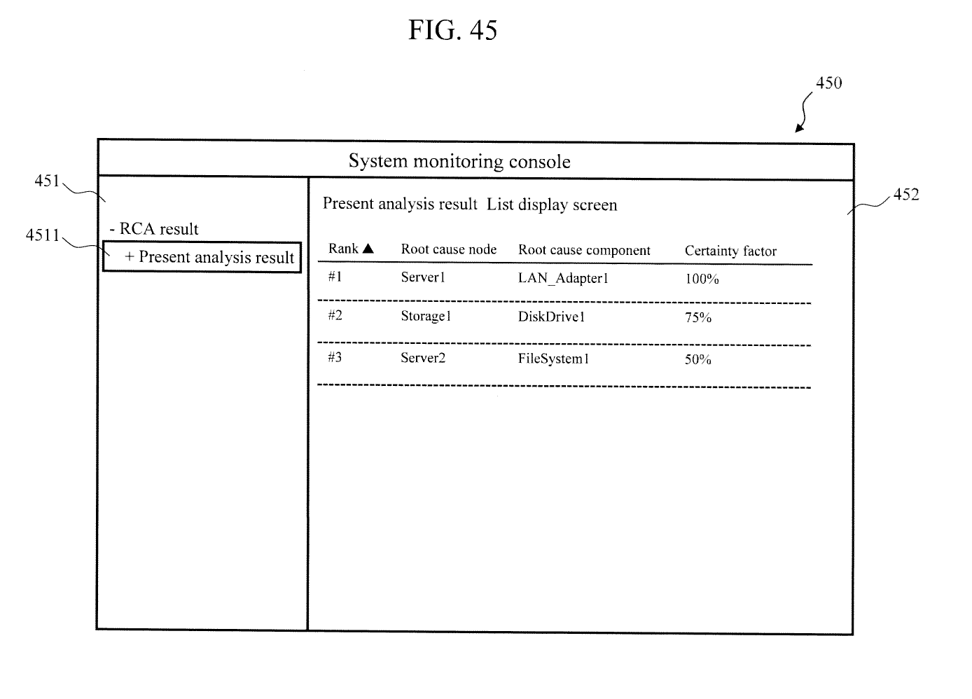

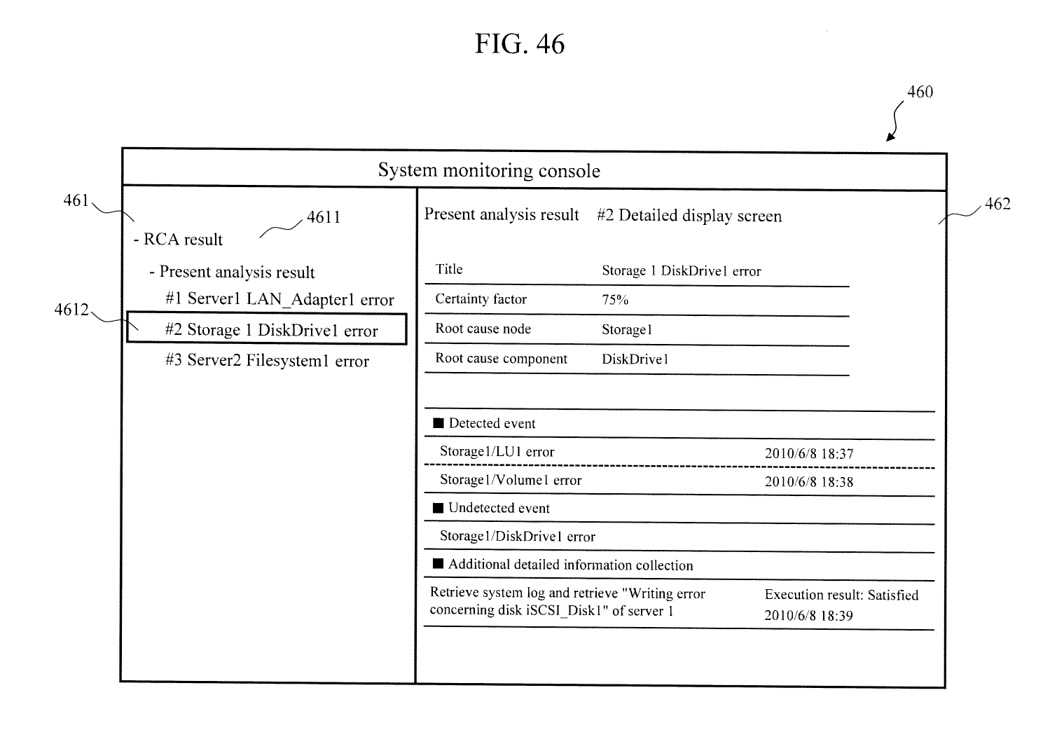

The GUI processing is processing for generating an RCA result output screen (a system monitoring console (FIGS. 45 and 46)) from the conclusion table 32170 and displaying the RCA result output screen on a display screen of the input/output device (a display apparatus) 32100.

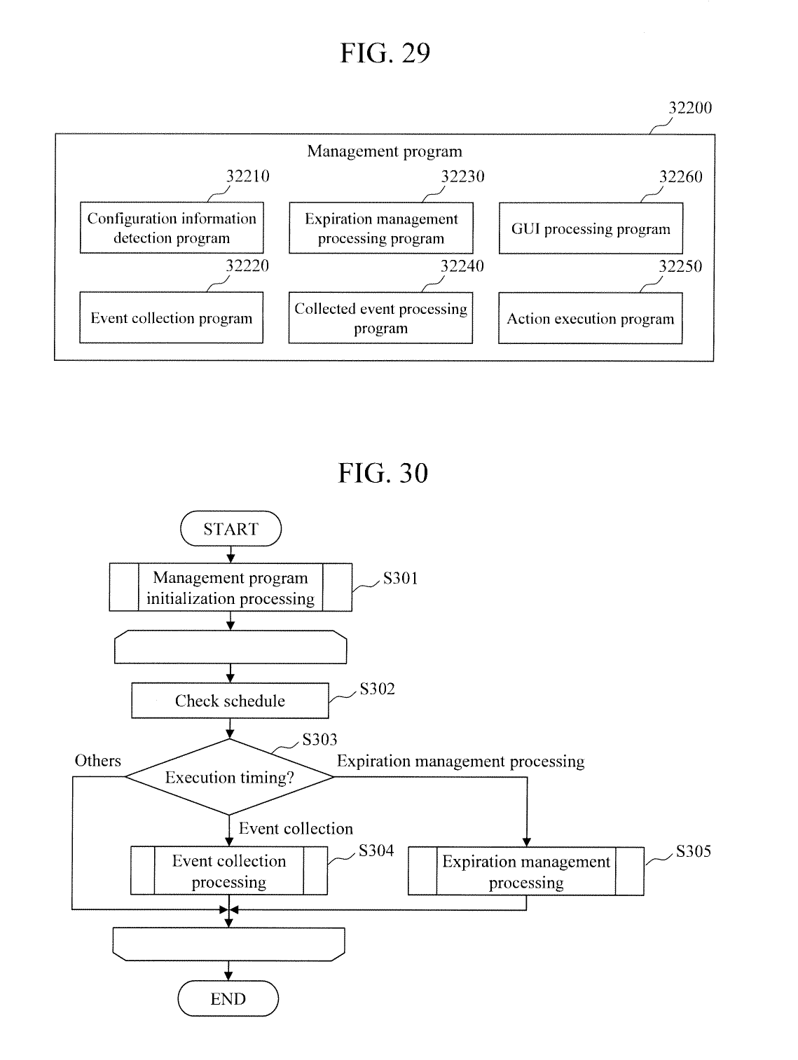

As shown in FIG. 29, the management program 32200 may be configured to include plural sub-programs. In this case, the plural sub-programs include a configuration information detection program 32210, an event collection program 32220, an expiration management processing program 32230, a collected event processing program 32240, an action execution program 32250, and a GUI processing program 32260.

Although not explained above and not shown in FIG. 29, the management program 32200 also executes processing for applying various kinds of configuration information to various universal rules and generating various expansion rules on the basis of patterns corresponding to the configuration information (see FIG. 15).

<Outline of Periodic Execution Processing by the Management Program>

FIG. 30 is a flowchart for explaining an overall outline of processing periodically executed by the management program 32200. In explanation of all flowcharts below, it is assumed that a processing entity of steps is the management program 32200.

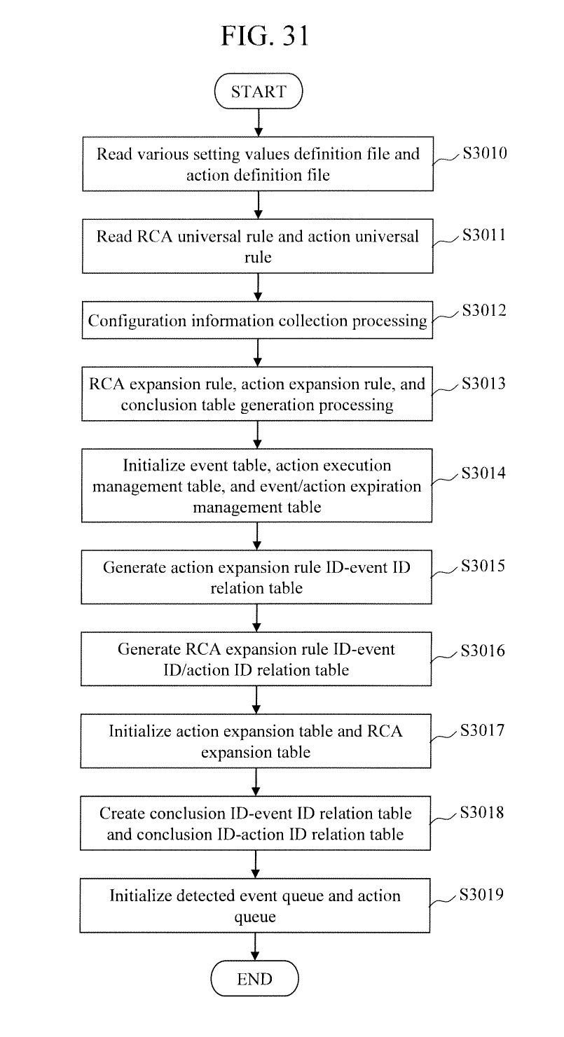

First, the management program 32200 executes management program initialization processing (S301). Details of this processing are explained in detailed with reference to FIG. 31.

The management program 32200 performs schedule check (S302). Specifically, the management program 32200 checks setting items and setting values defined in the various setting values definition table 32020, monitors monitoring target apparatuses, and checks whether it is timing for executing processing for collecting events from the monitoring target apparatuses (e.g., every 5 minutes) or timing for performing processing for determining whether there are expired event and action among collected events and satisfied actions (e.g., every 30 minutes).

Subsequently, the management program 32200 determines it is execution timing for the event collection processing or timing for checking expiration (S303). When it is neither the execution timing nor the timing for checking expiration, the management program 32200 returns to S302.

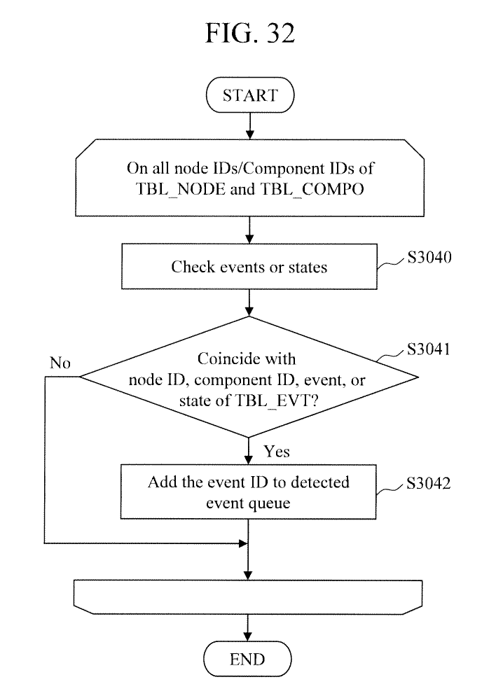

In the case of the timing for the event collection processing, the management program 32200 executes the event collection processing (S304). Details of the event collection processing are explained with reference to FIG. 32.

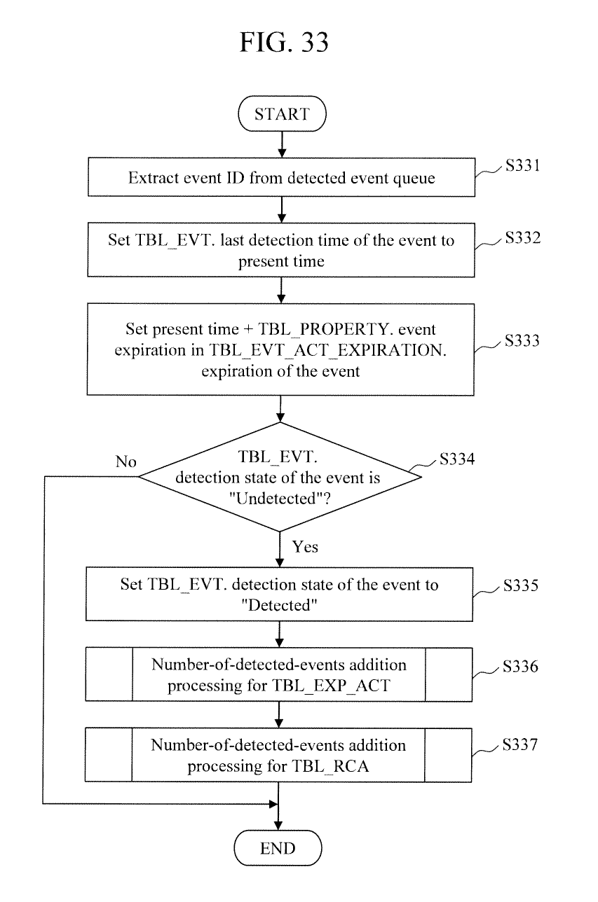

On the other hand, in the case of the timing for checking expiration, the management program 32200 executes the expiration management processing (S305). Details of the expiration management processing are explained with reference to FIG. 33.

<Management Program Initialization Processing>

FIG. 31 is a flowchart for explaining details of the management program initialization processing (S301 in FIG. 30). The management program initialization processing is executed, for example, when the management server (the management computer) 30000 is started or when necessity for initialization occurs again because the configuration of the computer system 1 is changed.

First, the management program 32200 reads the various setting values definition file 32020 and the action definition file 32030 (S3010) and reads an RCA universal rule and an action universal rule (S3011).

The management program 32200 accesses monitoring target apparatuses included in the computer system 1, acquires configuration information of the apparatuses and components thereof, and stores the configuration information respectively in the configuration-information-for-node management table 32080 and the configuration-information-for-component management table 32090 (S3012).

The management program 32200 applies the configuration information acquired in S3012 to the RCA universal rule and the action universal rule read in S3011 to generate an RCA expansion rule and an action expansion rule, and generates the conclusion table 32170 anew (S3013). As explained with reference to FIG. 15, the RCA expansion rule and the action expansion rule are generated by specifying related configuration information (a monitoring target apparatus and a component) according to a procedure indicated by relevant pattern information (e.g., in FIG. 15, a pattern 2) included in the universal rules. Concerning the conclusion table 32170, at a point of initialization processing, only fixed items are stored in the conclusion table 32170 and fluctuating items are left blank. Specifically, respective kinds of information are stored in the spaces of the conclusion ID 32171, the conclusion message 32172, the node ID 32173, and the component ID 32174 of the conclusion table 32170 but the spaces of the present rank 32175, the present certainty factor 32176, and the expansion rule ID used for a certainty factor calculation 32177 are left blank.

Subsequently, the management program 32200 initializes the event table 32100, the action execution management table 32140, and the event/action expiration management table 32150 (S3014). Specifically, in the event table 32100, fixed relevant information is inserted into the event ID 32101, the node ID 32102, the component ID 32103, and the event or state 32104. All states are undetected in the detection state 32105. The last detection time 32106 is set to blank. In the action execution management table 32140, fixed relevant information is inserted into the action ID 32141, the action type 32142, and the action target 32143. The execution state 32144 is set to on standby or Null (−). The last time execution result 32145 and the last execution result decision time 32146 are set to blank or Null (−).

The management program 32200 generates the action expansion rule ID-event ID relation table 32120 on the basis of the generated action expansion rule (S3015) and further generates the RCA expansion rule ID-event ID/action ID relation table 32130 on the basis of the generated RCA expansion rule (S3016).

Further, the management program 32200 initializes the action expansion rule table 32110 and the RCA expansion rule table 32160 (S3017). Specifically, in the action expansion rule table 32110, fixed relevant information is inserted into the spaces of the action expansion rule ID 32111, the execution action ID 32112, and the number of detected events or states necessary for action execution 32133 and the space of the number of detected events or states 32114 is set to blank. In the RCA expansion rule table 32160, on the basis of the RCA expansion rules, fixed relevant information is inserted into the spaces of the RCA expansion rule ID 32161, the conclusion ID 32162, and the total number of events/actions 32163 and the spaces of the number of detected events/number of satisfied actions 32164 and the certainty factor 32165 are set to blank.

The management program 32200 generates the conclusion ID-event ID relation table 32180 and the conclusion ID-action ID relation table 32190 (S3018). The conclusion ID-event ID relation table 32180 is a table for managing conclusions and detection states of related events necessary for determination leading to the conclusions. Therefore, at a stage of initialization, events (excluding actions) related to THEN clauses (conclusion parts) are extracted from the RCA expansion rules, fixed relevant information is inserted into the spaces of the conclusion ID 32181 and the event ID 32182, the space of the detection state 32183 is set to undetected, and the space of the detection time is set to blank or Null (−). The conclusion ID-action ID relation table 32190 is a table for managing conclusions and execution results of related actions necessary for determination leading to the conclusions. Therefore, at a stage of initialization, actions related to THEN clauses (conclusion parts) are extracted from the RCA expansion rules including actions, fixed relevant information is inserted into the spaces of the conclusion ID 32191 and the action ID 32192, the space of the detection state 32183 is set to undetected, and the space of the detection time 32184 is set to blank or Null (−).

Finally, the management program 32200 initializes the detected event queue 32210 and the action queue 32220 (S3019).

<Event Collection Processing>

FIG. 32 is a flowchart for explaining details of the event collection processing (S304). Processing in S3040 and S3042 explained below is executed on all combinations of the node ID 32081 and the component ID 32091 managed in the configuration-information-for-node management table (TBL_NODE) 32080 and the configuration-information-for-component management table (TBL_COMPO) 32090.

First, the management program 32200 transmits an event collection request to monitoring target apparatuses and checks events or states of a monitoring target apparatus (a node) and a component set as collection targets this time (S3040).

The management program 32200 determines whether information acquired in S3040 corresponding to the node ID 32102 and the component ID 32103 of the event table (TBL_EVT) 32100 coincides with information indicated by the event or state 32104 (S3041).

When it is determined that the information acquired in S3040 does not coincide with the information indicated by the event or state 32104 (in the case of No in S3041), the management program 32200 ends the processing concerning the combination of the node ID and the component ID and shifts the processing to the event collection processing for the next node ID and component ID.

On the other hand, when it is determined that the information acquired in S3040 coincides with the information indicated by the event or state 32104 (in the case of Yes in S3041), the management program 32200 adds the event ID 32101 corresponding to the information to the detected event queue 32210 (S3042).

At this stage, generated events are simply collected. Reflection of information on the event table 32100 is executed in the detected event processing shown in FIG. 33.

<Collected Event Processing>

FIG. 33 is a flowchart for explaining the collected event processing for reflecting collected (detected) events on the tables. Since the collected event processing is processing executed when input to a detection queue is performed, the collected event processing is processing not included in the periodic execution processing shown in FIG. 30 and executed independently from the periodic execution processing. The collected event processing is sequentially executed, for example, at timing when an event ID is input to a detected event queue.

First, the management program 32200 extracts one event ID from the detected event queue 32210 (S331).

The management program 32200 sets, concerning the extracted event, the last detection time 32106 of the event table (TBL_EVT) 32100 to the present time (S332). As the present time, for example, time when the management program 32200 inputs an event ID corresponding to the detected event queue 32210, time when the management program 32200 extracts an event ID corresponding to the detected event queue 32210 from the detected event queue 32210, time when the management program 32200 requests, during the event collection processing, monitoring target apparatuses to return detected events or states, time when the management program 32200 checks the returned events or states in S3040, and time when events or states are detected in the monitoring target apparatuses (time when the events or the states are described in a log) are conceivable.

The management program 32200 inputs, concerning the event, a value obtained by adding a setting value (e.g., 30 minutes) of the event valid period of the various setting values definition table (TBL_PROPERTY) 32020 to the last detection time (the present time) set in S332 to the space of the expiration 32153 of the event/action expiration management table (TBL_EVT_ACT_EXPIRATION) 32150 (S333). When the expiration 32153 is set, time measurement for determining validity of the event is started.

Subsequently, the management program 32200 determines whether the detection state 32105 of the event table (TBL_EVT) 32100 corresponding to the event is undetected (S334).

When the detection state 32105 is detected (in the case of No in S334), if the next event is present in the detected event queue, the management program 32200 subsequently executes processing concerning the event and, if the next event is not present, the management program 32200 ends the processing. In other words, when the detection state 32105 is detected, information in the spaces of the last detection time 32106 and the expiration 32153 concerning the event is simply updated.

On the other hand, when the detection state 32105 is undetected (in the case of Yes in S334), the management program 32200 changes, concerning the event, the detection state 32105 of the event table (TBL_EVT) 32100 from undetected to detected (S335).

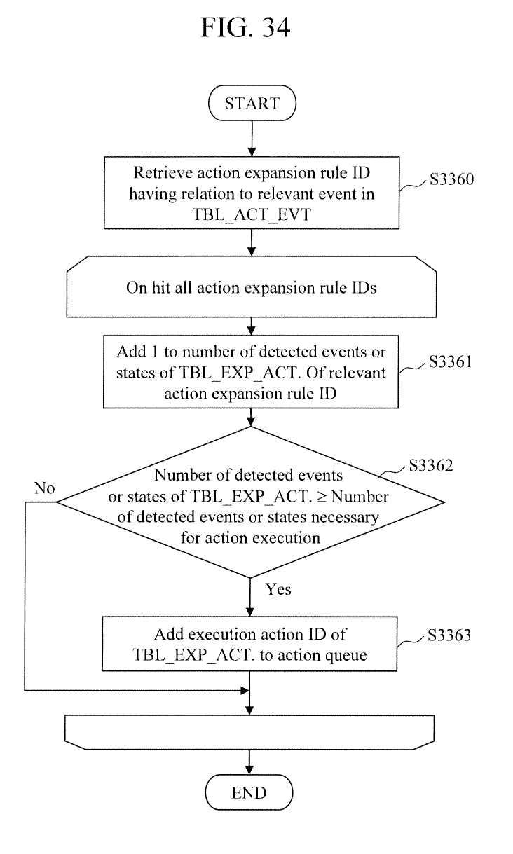

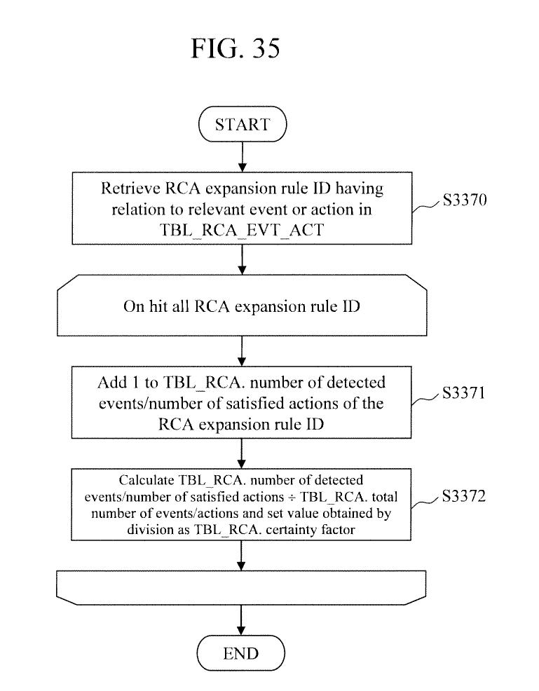

Further, the management program 32200 executes addition processing for the number of detected events or states 32114 of a relevant action expansion rule in the action expansion rule table (TBL_EXP_ACT) 32110 (S336) and addition processing for the number of detected events/number of satisfied actions 32164 of a relevant RCA expansion rule in the RCA expansion rule table (TBL_RCA) 32160 (S337). Details of S336 and S337 are respectively explained with reference to FIGS. 34 and 35.

If an event ID is still present in the detected event queue 32210, the management program 32200 repeats the processing of S311 to S337. If no event ID is present in the detected event queue 32210, the management program 32200 ends the collected event processing.

<Details of the Addition Processing for the Number of Detected Events of an Action Expansion Rule>

FIG. 34 is a flowchart for explaining details of the addition processing for the number of detected events of an action expansion rule (S336).

First, the management program 32200 refers to the action expansion rule ID-event ID relation table (TBL_ACT_EVT) 32120 and searches for an action expansion rule ID to which a relevant event (an event as a processing target) is related (S3360). Concerning all action expansion rule IDs acquired in this processing, processing in S3361 to S3363 explained below is executed.

The management program 32200 selects one action expansion rule ID and adds 1 to the number of detected events or states 32114 corresponding to the action expansion rule ID in the action expansion rule table (TBL_EXP_ACT) 32110 (S3361).

Subsequently, the management program 32200 refers to the action expansion rule table (TBL_ACT_EVT) 32110 and determines whether the number of detected events or states 32114 corresponding to the action expansion rule ID reaches (is equal to or larger than) the number of detected events or states necessary for action execution 32113 (S3362).

When the number of detected events or states 32114 does not reach the number of detected events or states necessary for action execution 32113 (in the case of No in S3362), the processing shifts to processing concerning the acquired action expansion rule IDs. If all the action expansion rule IDs acquired in S3360 are already processed, the management program 32200 ends the addition processing. If there is an unprocessed action expansion rule ID, the management program 32200 repeats the processing of S3361 to S3363.

When the number of detected events or states 32114 reaches the number of detected events or states necessary for action execution 32113 (in the case of Yes in S3363), the management program 32200 adds the relevant execution action ID 32112 of the action expansion rule table (TBL_ACT_EVT) 32110 to the action queue 32220 (S3363).

### <Details of the Addition Processing for the Number of Detected Events/Number of Satisfied Actions of an RCA Expansion Rule>

FIG. 35 is a flowchart for explaining details of the addition processing for the number of detected events/number of satisfied actions an RCA expansion rule (S337).

First, the management program 32200 refers to the RCA expansion rule ID-event ID/action ID relation table 32130 and searches for an RCA expansion rule ID to which a relevant event (an event as a processing target) is related (S3370). Processing in S3371 and S3372 is executed concerning all RCA expansion rule IDs acquired in this processing.

The management program 32200 selects one RCA expansion rule ID and adds 1 to the number of detected events/number of satisfied actions 32164 corresponding to the RCA expansion rule ID 32161 in the RCA expansion rule table (TBL_RCA) 32160 (S3371).

The management program 32200 divides the number of detected events/number of satisfied actions 32164 of the RCA expansion rule by a total number of events/actions and sets a value obtained by the division as the certainty factor 32165 (S3372).

If all the RCA expansion rule IDs acquired in S3370 are already processed, the management program 32200 ends the addition processing. If an unprocessed RCA expansion rule ID is present, the management program 32200 repeats the processing in S3371 and S3372.

<Expiration Management Processing>

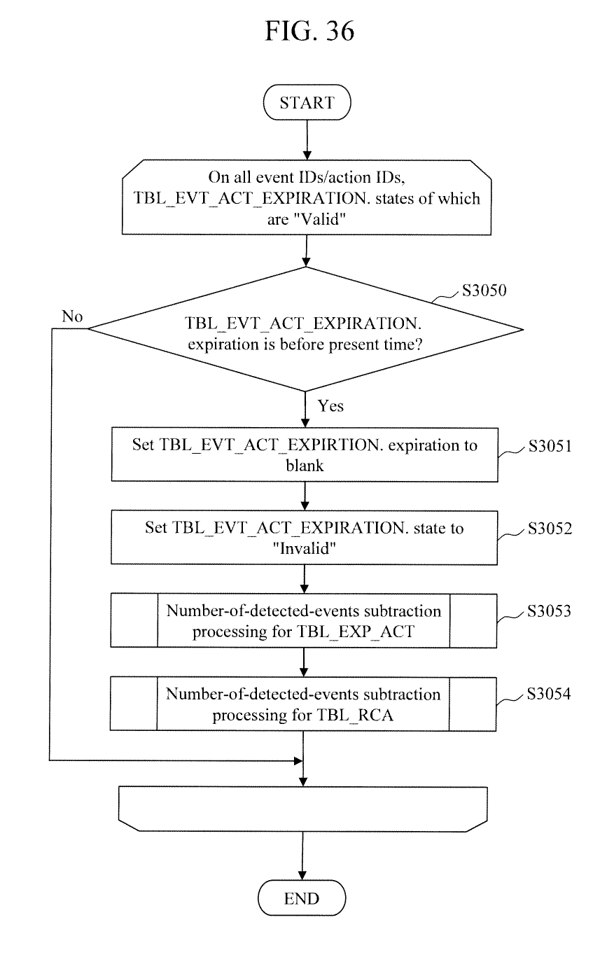

FIG. 36 is a flowchart for explaining details of the expiration management processing (S305 in FIG. 30). Processing in S3050 to S3054 is executed concerning all event IDs and action IDs for which the state 32152 in the event/action expiration management table 32150 is set to valid.

First, the management program 32200 refers to the event/action expiration management table (TBL_EVT_ACT_EXPIRATION) 32150 and determines, concerning one event ID/action ID, whether the relevant expiration 32153 is before the present time (an event or an action is expired) (S3050). The present time means time when the expiration management processing is started concerning the event ID/action ID.

When the event or action is not expired (in the case of No in S3050), the processing shifts to processing of the next event ID/action ID or ends.

When the event or action is expired (in the case of Yes in S3050), the management program 32200 sets the space of the expiration 32153 of the event ID/action ID to blank or Null (−) (S3051) and further sets the space of the state 32152 from valid to invalid (S3052).

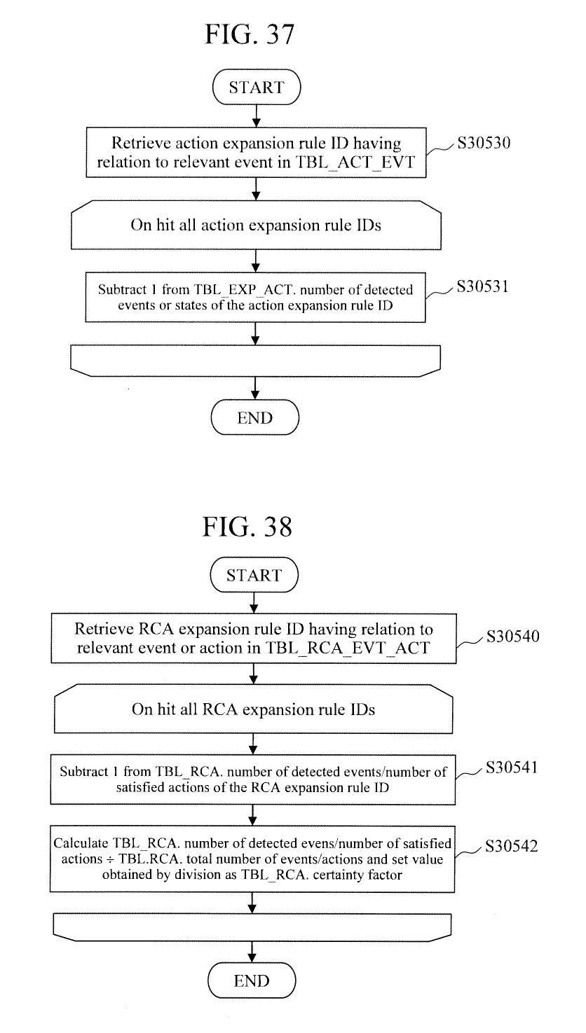

Subsequently, the management program 32200 executes subtraction processing for the number of detected events or states 32114 of a relevant action expansion rule in the action expansion rule table (TBL_EXP_ACT) 32110 (S3053) and addition processing for the number of detected events/number of satisfied actions 32164 of a relevant RCA expansion rule in the RCA expansion rule table (TBL_RCA) 32160 (S3054). Details of S3053 and S3054 are respectively explained with reference to FIGS. 37 and 38.

If an unprocessed event ID/action ID is still present, the management program 32200 repeats the processing in S3050 to S3054. If no unprocessed event ID/action ID is present, the management program 32200 ends the expiration processing.

<Details of the Subtraction Processing for the Number of Detected Events or States 32114 of an Action Expansion Rule>

FIG. 37 is a flowchart for explaining details of the subtraction processing for the number of detected events or states 32114 of an action expansion rule (S3053).

First, the management program 32200 refers to the action expansion rule ID-event ID relation table (TBL_ACT_EVT) 32120 and retrieves an action expansion rule ID to which a relevant event (an event as a processing target) is related (S30530). Processing in S30531 explained below is executed concerning all action expansion rule IDs acquired in this processing.

The management program 32200 selects one action expansion rule ID and subtracts 1 from the number of detected events or states 32114 corresponding to the action expansion rule ID in the action expansion rule table (TBL_EXP_ACT) 32110 (S30351).

If all the action expansion rule IDs acquired in S30530 are already processed, the management program 32200 ends the addition processing. If an unprocessed action expansion rule ID is present, the management program 32200 repeats the processing in S30351.

<Details of the Subtraction Processing for the Number of Detected Events/Number of Satisfied Actions of an RCA Expansion Rule>

FIG. 38 is a flowchart for explaining details of the subtraction processing for the number of detected events/number of satisfied actions of an RCA expansion rule (S3054).

First, the management program 32200 refers to the RCA expansion rule ID-event ID/action ID relation table (TBL_RCA_EVT_ACT) 32130 and retrieves an RCA expansion rule ID to which a relevant event (an event as a processing target) is related (S30540). Processing in S30541 and S30542 explained below is executed concerning all RCA expansion rules ID acquired in this processing.

The management program 32200 selects one RCA expansion rule ID and subtracts 1 from the number of detected events/number of satisfied actions 32164 corresponding to the RCA expansion rule ID 32161 of the RCA expansion rule table (TBL_RCA) 32160 (S30541).

The management program 32200 divides the number of detected events/number of satisfied actions 32164 of a relevant RCA expansion rule by a total number of events/actions and sets a value obtained by the division as the certainty factor 32165 (S30542).

If all the RCA expansion rule IDs acquired in S30540 are already processed, the management program 32200 ends the addition processing. If an unprocessed RCA expansion rule ID is present, the management program 32200 repeats the processing in S30541 and S30542.

<Action Execution Processing>

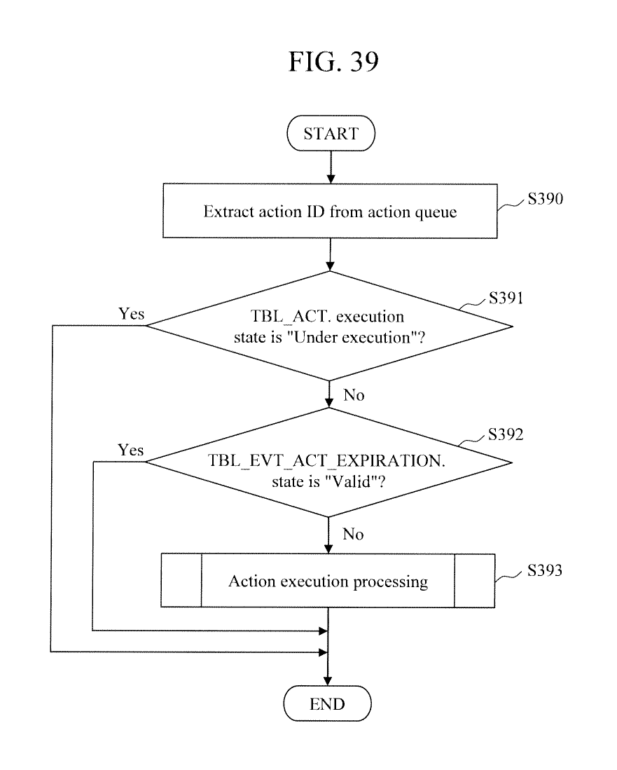

FIG. 39 is a flowchart for explaining action execution executed by the management program 32200. The action execution processing is sequentially executed, for example, at timing when the execution action ID 32112 is input to the action queue 32220.

First, the management program 32200 extracts one execution action ID from the action queue 32220 (S390), refers to the action execution management table (TBL_ACT) 32140, and determines whether the execution state 32144 of the execution action ID is under execution (S391). When the same action is executed by another event, if execution of the same action is processed from the present event, the management program 32200 ends the same action executed earlier. The present action is not executed and an action execution result of the last time is diverted as an action execution result of this time.

When the execution state is under execution (in the case of Yes in S391), the management program 32200 ends the processing concerning the action ID.

When the execution state is not under execution (in the case of No in S391), the management program 32200 refers to the event/action expiration management table (TBL_EVT_ACT_EXPIRATION) 32150 and determines whether the state 32152 is valid (S392).

When the state is valid (in the case of Yes in S392), the management program 32200 ends the processing concerning the action ID. In this case, since an execution result of the same action has not expired yet, the same execution result is diverted to the execution action ID. Consequently, processing is made efficient without executing the same action many times even if the same action execution command is issued within a predetermined time.

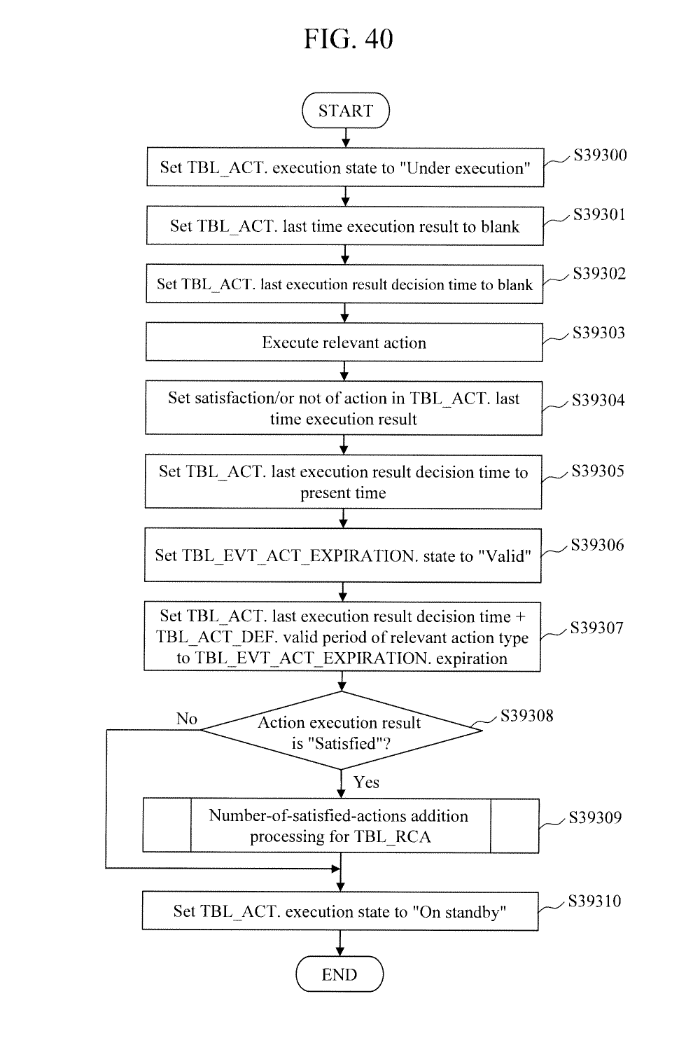

When the state is invalid (in the case of No in S392), the management program 32200 executes an action corresponding to the action ID (S393). Details of this action execution processing are explained with reference to FIG. 40.

<Details of the Action Execution Processing>

FIG. 40 is a flowchart for explaining details of the action execution processing (S393).

The management program 32200 sets, in the action execution management table (TBL_ACT) 32140, the space of the execution state 32144 corresponding to the action ID 32141 of the processing target to under execution (S39300).

The management program 32200 sets the space of the last time execution result 32145 to blank (S39301) and further sets the space of the last execution result decision time 32146 to blank (S39392). This is because, if an execution result of this time is obtained, an execution result of the last time and information concerning last execution result decision time are unnecessary.

The management program 32200 executes an action specified by an action ID set as a processing target (S39303). Content of the action to be executed is specified by the action type 32031 and the action content 32034 of the action definition table (TBL_ACT_DEF) 32030.

When an execution result is obtained, the management program 32200 sets, according to content of the execution result, satisfaction or not in the space of the last time execution result 32145 of the action execution management table (TBL_ACT) 32140 (S390304) and sets the present time in the space of the last execution result decision time 32146 (S39305). The present time means time specified within a series of processing related to action execution such as time when an action ID is extracted from an action queue, time when execution of an action is actually started, time when a check request for a system log is transmitted to a relevant monitoring target apparatus, time when a reply to the request is received from the monitoring target apparatus, and time when whether or not an action is satisfied is decided from the received replay.

Further, the management program 32200 sets, in the event/action expiration management table (TBL_EVT_ACT_EXPIRATION) 32150, the space of the state 32152 corresponding to the action ID as the processing target to valid (S39306) and adds the valid period 32033 of the relevant action type 32031 defined by the action definition table 32030 to the last execution result decision time set in S39305 and sets the expiration 32153 (S39307).

Subsequently, the management program 32200 determines whether the action execution result obtained in S39303 is satisfaction (S39308). When the action execution result is not satisfied (in the case of No in S39308), the processing shifts to S39310.

When the action execution result is satisfaction (in the case of Yes in S39308), the management program 32200 adds 1 to the number of detected events/number of satisfied actions 32164 of the RCA expansion rule table (TBL_RCA) 32160 (S39309). Details of S39309 are the same as the processing explained with reference to FIG. 35.

Finally, the management program 32200 sets the space of the execution state 32144 of the action execution management table (TBL_ACT) 32140 to on standby and ends the action execution processing (S39310).

<RCA Result Output Processing>

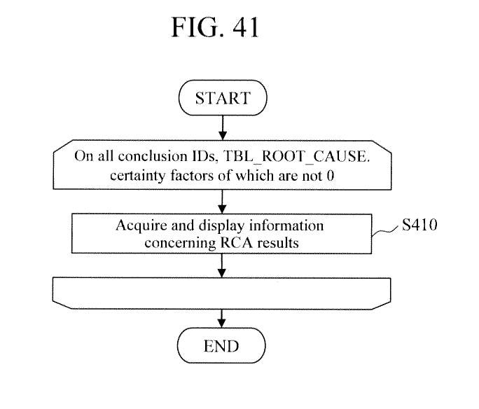

FIG. 41 is a flowchart for explaining the RCA result output processing executed by the management program 32200. The management program 32200 executes processing in S410 explained below on all conclusion IDs 32171, the certainty factor 32176 of which is not 0 in the conclusion table (TBL_ROOT_CAUSE) 32170. The management program 32200 may execute S410 only on the conclusion ID 32171, a value of the present certainty factor 32176 of which is equal to or larger than a predetermined value, or the conclusion ID 32171, the present rank 32175 of which is equal to or higher than a predetermined rank.

The management program 32200 refers to the conclusion table 32170, acquires the information 32172 to 32177 corresponding to conclusion IDs set as targets, and subjects the information 32172 to 32177 to GUI processing and displays the information on a display screen (S410). Examples of the GUI screen include system monitoring consoles shown in FIGS. 45 and 46. The system monitoring consoles are explained later.

<Conclusion Table Update Processing>

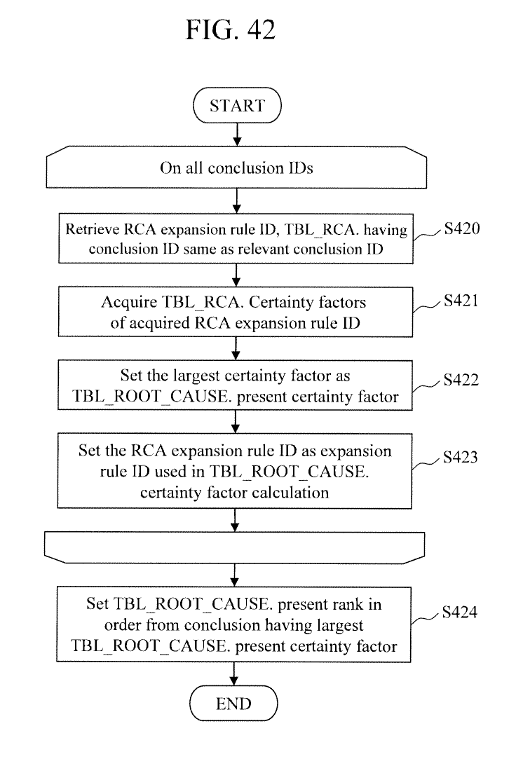

FIG. 42 is a flowchart for explaining the conclusion table update processing executed by the management program 32200. The processing is executed on all conclusion IDs included in the conclusion table 32170.

First, the management program 32200 acquires, concerning one conclusion ID, at least one RCA expansion rule ID 32161 having the same conclusion ID 32161 in the RCA expansion rule table (TBL_RCA) 32160 (S420) and acquires values of the certainty factor 32165 corresponding to the acquired RCA expansion rule ID 32161 (S421).

The management program 32200 sets a maximum among the certainty factors acquired in S421 as a value of the present certainty factor 32176 in the conclusion table (TBL_ROOT_CAUSE) 32170 (S422). In some cases, plural RCA expansion rules leading to the same conclusion are present. However, a result with the highest certainty factor (accuracy of a root cause analysis result) among the RCA expansion rules is selected.

The management program 32200 sets the RCA expansion rule ID 32161 having the certainty factor 32165 selected in S422 in the space of the expansion rule ID 32171 used for the certainty factor calculation for the conclusion table (TBL_ROOT_CAUSE) 32170 (S423). In the conclusion table (TBL_ROOT_CAUSE) 32170, only one RCA expansion rule corresponds to one conclusion ID. However, an RCA expansion rule other than an RCA expansion rule indicating the present certainty factor may be input. However, in this case, it is necessary to clearly indicate which RCA expansion rule provides the present certainty factor.

The processing in S420 to S423 is executed on all the conclusion IDs 32171 of the conclusion table (TBL_ROOT_CAUSE) 32170. Information of the present certainty factor 32176 equivalent to the number of the conclusion IDs 32171 is obtained.

The management program 32200 sets the present rank 32175 in order from the conclusion ID 32171 having the largest present certainty factor among the obtained plural present certainty factors (S424).

<Conclusion ID-Event ID Relation Table Update Processing>

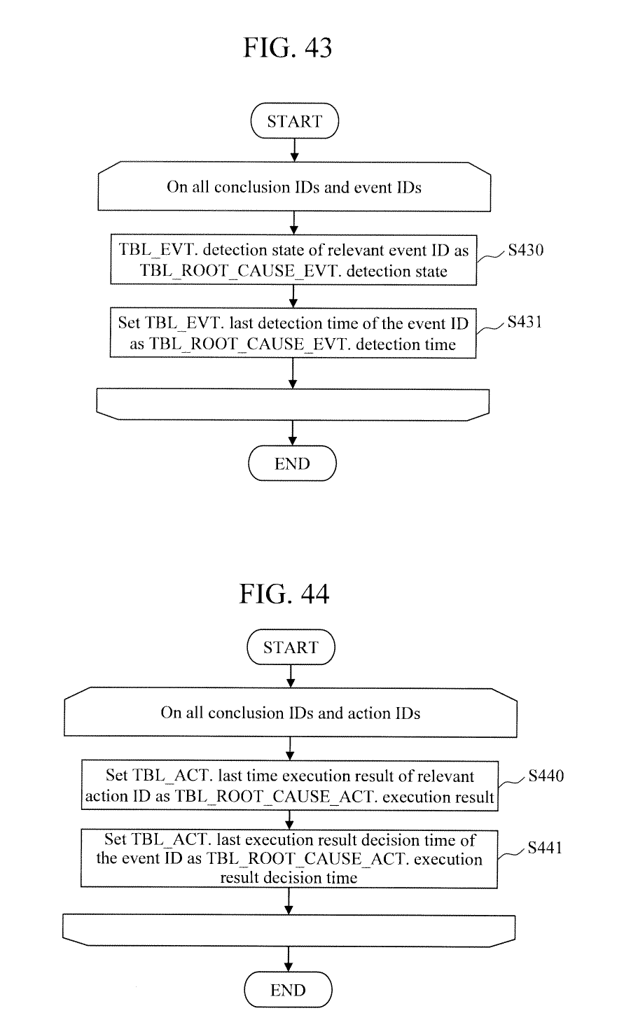

FIG. 43 is a flowchart for explaining the conclusion ID-event ID relation table update processing executed by the management program 32200. This processing is executed concerning all sets of the conclusion ID 32181 and the event ID 32182 in the conclusion ID-event ID relation table 32180.

First, the management program 32200 selects one set of the conclusion ID 32181 and the event ID 32182 from the conclusion ID-event ID relation table (TBL_ROOT_CAUSE_EVT) 32180 and sets the detection state 32183 of the conclusion ID-event ID relation table (TBL_ROOT_CAUSE_EVT) 32180 to a value (detected or undetected) same as the detection state 32105 corresponding to the event ID 32101 in the event table (TBL_EVT) 32100 (S430).

Further, the management program 32200 sets a value of the detection time 32184 of the conclusion ID-event ID relation table 32180 to a value same as the last detection time 32106 corresponding to the event ID 32101 in the event table (TBL_EVT) 32100 (S431).

As explained above, all kinds of information of the detection state 32183 and the detection time 32184 in the conclusion ID-event ID relation table (TBL_ROOT_CAUSE_EVT) 32180 are updated.

<Conclusion ID-Action ID Relation Table Update Processing>

FIG. 44 is a flowchart for explaining the conclusion ID-action ID relation table update processing executed by the management program 32200. This processing is executed concerning all sets of the conclusion ID 32191 and the action ID 32192 in the conclusion ID-action ID relation table (TBL_ROOT_CAUSE_ACT) 32190.

First, the management program 32200 selects one set of the conclusion ID 32191 and the action ID 32192 from the conclusion ID-action ID relation table 32190 and sets the execution result 32193 of the conclusion ID-action ID relation table (TBL_ROOT_CAUSE_ACT) 32190 to a value (satisfied or not satisfied) same as the last time execution result 32145 corresponding to the action ID 32141 in the action execution management table (TBL_ACT) 32140 (S440).

Further, the management program 32200 sets a value of the execution result decision time 32194 of the conclusion ID-action ID relation table (TBL_ROOT_ACT) 32190 to a value same as the last execution result decision time 32146 corresponding to the action ID 32141 in the action execution management table 32140 (S441).

As explained above, all kinds of information of the execution result 32193 and the execution result decision time 32194 in the conclusion ID-action ID relation table (TBL_ROOT_CAUSE_ACT) 32190 are updated.

<Example of an RCA Result Output Screen>

FIG. 45 is a diagram showing an example of an RCA result output screen (a present result: list display) 450. FIG. 46 is a diagram showing an example of an RCA result output screen (a present result: detailed display) 460.

The RCA result output screen (a present result: list display) 450 includes an RCA result type plane 451 and an RCA result list display plane 452.

In the RCA result plane 451, only a present analysis result is shown as a type. However, the RCA result plane 451 is not limited to this and may include a past RCA result as a type. In the list display plane 451, a list of RCA results sorted according to the present rank 32175 of the conclusion table 32170 is displayed.

The RCA result output screen (a present result: detailed display) 460 includes an RCA result type plane 461 and an RCA result detailed display plane 462.

The RCA result type plane 461 has content in which the RCA result type plane 451 is descried more in detail. In FIG. 45, when a + present analysis result 4511 is clicked, a − present analysis result 4611 is displayed. A list of root causes of failures detected by RCA is displayed below the − present analysis result 4611.

Detailed content of a selected root cause is displayed in the RCA result detailed display plane. For example, when one root cause is selected from the list display of the root causes of the RCA result type plane 461, detailed content of the root cause is displayed in the RCA result detailed display plane 462. In the example shown in FIG. 46, a root cause 4612 is selected and details of the root cause 4612 are displayed.

### Summary of the Embodiment

As explained above, in this embodiment, a separately-defined action is set in an expansion rule, a certainty factor is calculated on the basis of whether or not a condition event and an action execution result are satisfied, and an RCA result is generated. This action is processing for checking whether or not a substitute condition event equivalent to a condition event not easily detected in the conventional expansion rule is satisfied. This action is, for example, an action for checking a system log in a monitoring target apparatus and detecting presence or absence of an error or the like. Necessity of action execution is determined according to whether a predetermined number f condition events other than the action defined in the expansion rule are satisfied (different according to an expansion rule) (an action expansion rule). Consequently, since presence or absence of even an error not easily detected is checked by another kind of means, it is possible to provide an RCA result with a higher certainty factor. Even when an information amount is small and a root cause analysis cannot be performed, since an action execution result can be included in the root cause analysis processing as additional information, it is possible to provide an RCA result with a higher certainty factor. Further, since an action rule is simply introduced anew, it is possible to reduce cost (a processing load, a consumed memory capacity, and processing time) in management of a computer system can be reduced. The action expansion rule is configured to include condition events of an RCA expansion rule corresponding to the action expansion rule. Necessity of action execution is determined according to the number of satisfied condition events. However, the action expansion rule is not limited to this. The action expansion rule may include events or states not coinciding with the condition events included in the corresponding RCA expansion rule. Specifically, when events or states a, b, and c and an action X are included in the RCA expansion rule as condition events, as condition events of an action rule for determining execution of the action X, events or states d, e, and f may be included in addition to or separately from at least a part of the events or states a, b, and c.

In this embodiment, it is sequentially managed concerning whether detected condition events and execution results of actions are valid or invalid. A certainty factor is sequentially calculated again according to a change in a state (a change from invalid to valid or a change from valid to invalid) of the condition events and the action execution results. Consequently, it is possible to provide certainty factor information with higher reliability.

Further, during execution of an action or within a set time from a point when an execution result of an action is acquired, when execution of actions same as the action is continuously instructed, the same action is not executed and an execution result of the action already acquired is used as an execution result of the same action. In this way, the same execution result is diverted to the same action execution request within a fixed period. Consequently, it is possible to save useless processing and hold down management cost of a computer system while maintaining accuracy of a certainty factor at fixed or higher accuracy.

In this embodiment, the list display (FIG. 45) and the detailed display (FIG. 46) are provided as an RCA result output screen. Consequently, it is possible to provide the administrator with convenience for dealing with a root cause.

The present invention is not limited to the embodiment per se. At an implementation stage, the components can be modified and embodied without departing from the spirit of the present invention. Various inventions can be formed according to appropriate combinations of plural components disclosed in the embodiment. For example, several components may be deleted from all the components described in the embodiment. Further, components of different embodiments may be combined as appropriate.

A part or all of the components, the functions, the processing units, the processing means, and the like described in the embodiment may be realized by hardware by, for example, designing the components, the functions, the processing units, the processing means, and the like with integrated circuits. The components, the functions, and the like may be realized by a processor interpreting and executing programs for realizing the respective functions. Information concerning programs, tables, files, and the like for realizing the functions and the like can be stored in a recording or storing device such as a memory, a hard disk, or an SSD (Solid State Drive) or a recording or storing medium such as an IC card, an SD card, or a DVD.

Further, in the embodiment explained above, control lines and information lines necessary for explanation are shown. Not all control lines and information lines are shown in terms of a product. All the components may be connected to one another.

### REFERENCE SIGNS LIST

10000: monitoring target apparatus (host computer)
10010: monitoring target apparatus (host computer)
20000: monitoring target apparatus (storage apparatus)
   20010: monitoring target apparatus (storage apparatus)
30000: management server
35000: WEB browser starting server
40000: monitoring target apparatus (network apparatus)
40010: monitoring target apparatus (network apparatus)
45000: network

1. A management system which is coupled to one or more node apparatuses as monitoring targets via a network and manages the one or more node apparatuses, the management system comprising:
a processor which detects events or states of the one or more node apparatuses; and
a memory which stores an analysis rule indicating a relation among a first condition group as one or more events or states which could occur in each of the one or more node apparatuses, a second condition group as one or more events or states different from the first condition group which could occur in each of the one or more node apparatuses, and a failure cause specified according to satisfaction of the first condition group and satisfaction of the second condition group,
wherein the analysis rule further describes a third condition group as one or more event or states which could occur in the one or more node apparatuses for determining whether determination of the second condition group is performed or the second condition group is regarded as not satisfied, and
wherein the processor applies the detected events or states to the analysis rule, performs determination of whether or not the second condition group is satisfied on the basis of whether or not the third condition group is satisfied, calculates, on the basis of determination results of whether or not the first condition group and the second condition group are satisfied, a certainty factor as information indicating a possibility of occurrence of a failure in the one or more node apparatuses to generate a root cause analysis result, and outputs the root cause analysis result.

2. A management system according to claim 1,
wherein the memory stores, separately from the analysis rule, an action rule for determining necessity of determination of whether or not the second condition group is satisfied,
the action rule specifies a command for instructing action execution for determining whether or not the second condition group is satisfied when conditions equal to or more than a predetermined number in the third condition group included in the analysis rule are satisfied, and
the processor determines necessity of execution of the action according to the action rule and calculates the certainty factor on the basis of the number of satisfied or not satisfied conditions of the first condition group and the second condition group with an execution result of the action set as the second condition group in the analysis rule.

3. A management system according to claim 2, wherein the action includes processing for checking whether a relevant error is present in a system log in the node apparatuses.

4. A management system according to claim 1, wherein the processor manages validity of the detected events or states of the one or more node apparatuses corresponding to the first condition group and an execution result of the action on the basis of detection time of the events or the states, execution result decision time, and set expiration information, and sequentially calculates the certainty factor again according to a change in the validity.

5. A management system according to claim 1, wherein, when execution of an action same as the action is instructed during execution of the action or within a set time from a point when an execution result of the action is acquired, the processor does not execute the same action and uses the execution result of the action as an execution result of the same action.

6. A management system according to claim 1, wherein, when a plurality of the obtained root cause analysis results are present, the processor displays the plurality of root cause analysis results on a display screen in order from a one having a highest certainty factor.

7. A management system according to claim 6, wherein, when one of the displayed plurality of root cause analysis results is selected, the processor displays detailed items of the root cause analysis result including a conclusion message equivalent to content of the failure cause on the display screen.

8. A management method for managing, using a management system, one or more node apparatuses as monitoring targets coupled to the management system via a network,
the management system including: a processor; and a memory which stores an analysis rule indicating a relation among a first condition group as one or more events or states which could occur in each of the one or more node apparatuses, a second condition group as one or more events or states different from the first condition group which could occur in each of the one or more node apparatuses, and a failure cause specified according to satisfaction of the first condition group and satisfaction of the second condition group, and
the analysis rule further describing a third condition group as one or more event or states which could occur in the one or more node apparatuses for determining whether determination of the second condition group is performed or the second condition group is regarded as not satisfied,
the management method comprising:
the processor detecting events or states of the one or more node apparatuses;
the processor applying the detected events or states to the analysis rule;
the processor performing determination of whether or not the second condition group is satisfied on the basis of whether or not the third condition group is satisfied and calculating, on the basis of determination results of whether or not the first condition group and the second condition group are satisfied, a certainty factor as information indicating possibility of occurrence of a failure in the one or more node apparatuses to generate a root cause analysis result; and
the processor outputting the root cause analysis result.

9. A management method according to claim 8,
wherein the memory stores, separately from the analysis rule, an action rule for determining a necessity of determination of whether or not the second condition group is satisfied,
the action rule specifies a command for instructing action execution for determining whether or not the second condition group is satisfied when conditions equal to or more than a predetermined number in the third condition group included in the analysis rule are satisfied, and
the processor determines necessity of execution of the action according to the action rule and calculates the certainty factor on the basis of the number of satisfied or not satisfied conditions of the first condition group and the second condition group with an execution result of the action set as the second condition group in the analysis rule.

10. A management method according to claim 9, wherein the action includes processing for checking whether a relevant error is present in a system log in the one or more node apparatuses.

11. A management method according to claim 8, wherein the processor manages validity of the detected events or states of the one or more node apparatuses corresponding to the first condition group and an execution result of the action on the basis of detection time of the events or the states, execution result decision time, and set expiration information, and sequentially calculates the certainty factor again according to a change in the validity.

12. A management method according to claim 8, wherein, when execution of an action same as the action is instructed during execution of the action or within a set time from a point when an execution result of the action is acquired, the processor does not execute the same action and uses the execution result of the action as an execution result of the same action.

13. A management method according to claim 8, wherein, when a plurality of the obtained root cause analysis results are present, the processor displays the plurality of root cause analysis results on a display screen in order from a one having a highest certainty factor.

14. A management method according to claim 13, wherein, when one of the displayed plurality of root cause analysis results is selected, the processor displays detailed items of the root cause analysis result including a conclusion message equivalent to content of the failure cause on the display screen.
